(19) United States
(12) Patent Application Publication
(10) Pub. No.: US 2008/0052247 A1
(43) Pub. Date: Feb. 28, 2008

(54) LEASE PROPOSAL SYSTEM AND METHOD

(76) Inventor: Michael J. Walker, Glen Ellyn, IL (US)

Correspondence Address: PATENT GROUP;C/O DLA PIPER US LLP, 203 N. LASALLE ST., SUITE 1900, CHICAGO, IL, 60601, US

(21) Appl. No.: 11/846,149

(22) Filed: Aug. 28, 2007

Related U.S. Application Data
(60) Provisional application No. 60/823,733, filed on Aug. 28, 2006.

(51) Int. Cl. G06Q 50/00

(52) U.S. Cl. 705/80

(57) ABSTRACT

A system for obtaining lease proposals from multiple landlords for a tenant includes a tenant workstation, a number of landlord workstations and a server in communication with the tenant and landlord workstations. The server features software and memory storage which permits a tenant to input tenant information using the tenant workstation and the landlords to input landlord information using the landlord workstations. The software also permits the tenant to generate requests for proposal having terms using the tenant information, transmit the requests for proposals to the landlord workstations and review landlord information. The software also permits the landlords to review the requests for proposal, accept the terms of the requests for proposal, generate lease proposals and transmit the lease proposals to the tenant workstation.

### CLAIM OF PRIORITY

This application claims priority from U.S. Provisional Patent Application Ser. No. 60/823,733, filed Aug. 28, 2006, currently pending.

### FIELD OF THE INVENTION

The invention relates generally to commercial real estate leasing and, more particularly, to a system and method that enables tenants to efficiently and effectively request, gather and evaluate lease proposals from landlords using a computer network such as the Internet.

### BACKGROUND

Commercial real estate tenants who lease their space (as opposed to owning) are faced with the chore of researching their real estate alternatives 1) at the end of their lease term, 2) when opening a new location in a new market and 3) when opening additional locations in markets they had previously covered.

In most instances, these tenants, who are typically companies, engage a real estate professional to represent them in the process of deciding which location best fits their requirements as it relates to location, amenities and economic restraints, among other things. In some cases, the companies may have an in-house real estate department that handles this process making it unnecessary for them to hire an outside real estate professional.

Regardless of whether this process is handled in-house or contracted out to a real estate professional, the intent of the process is the same: collect the most accurate and comprehensive information possible about all properties so that an educated decision may be made in regards to which location best fits the company's requirements as mentioned above.

Moreover, it should be noted that proposals to tenants from landlords are not commonly accepted on the first offer. Instead, there is typically a negotiation process that begins once the proposals from different buildings' landlords and the tenant, or the tenant's representative as the case may be, has had a chance to analyze the information in those proposals and compare the terms of those proposals side-by-side. Once that information is compared, it is typical for the tenant to create a negotiation strategy that includes 1) identification of which building is the preferred location of choice and 2) at what price and terms the tenant would be willing to enter into a lease with said landlord, usually identified in a “counter offer” to the original proposal.

For this reason, it is critical that the initial proposals for the landlords of choice are as detailed and comprehensive as possible so the tenant can make the most educated decision on which location offers the most benefits for the best economical terms. The more information that can be collected, the more effective subsequent negotiations will be and the more thorough the ultimate decision on where to locate the company's business will be.

Although the leases signed by tenants represent high value, (each 20,000 square feet represents $5 million on a typical 10 year lease at $25 per square foot) there is a decided lack of thoroughness and timeliness in the current request-for-proposal/proposal-submittal process, leading to decisions on eventual location and negotiating strategy based on incomplete and inaccurate information.

The overwhelming majority of commercial real estate companies nationwide typically use a mutually accepted process of negotiating commercial leases. Both the tenant and tenant's representative (collectively the “Tenant” in the steps below) (when requesting a proposal form the landlord) and the landlord and landlord's representative (collectively the “Landlord” in the steps below) (when submitting a proposal) use this accepted information gathering process. This process typically includes the following steps:
1. Tenant delivers request for proposals to selected Landlords along with request for commission agreement. Sometimes, both are verbal requests.
2. Tenant receives proposals from Landlords covering business terms (but not always received in the format requested and doesn't usually get a written commission agreement at same time).
3. Tenant analyzes business terms of Landlord(s) proposal(s), identifies building of choice, negotiates with Landlord of that building and comes to agreement in concept.
4. Landlord requests financial information from Tenant.
5. Tenant delivers financial information and Landlord establishes security required on the lease.
6. Landlord and Tenant negotiate on amount of security required.
7. Landlord and Tenant enter into a written “letter of intent.”
8. Tenant's attorney reviews lease and makes suggested changes (leases generally favor the Landlord).
9. Landlord's attorney and Tenant's attorney negotiate lease terms and modifications to landlords standard lease form.
10. Landlord and Tenant execute a mutually agreed upon lease document.

While this 10-step process works for most of the industry, improvements and efficiencies can be made to most steps of the process, leading to an information collection system that is more timely, accurate and comprehensive, thus benefiting both the tenant and the tenant's representative. Below are examples of problems that exist with the current method and process of moving from the request for proposal to an executed lease document.

In step #1 above, it is typical to start the process by a Tenant delivering a request for proposal (RFP) to the Landlord along with a commission agreement. The commission agreement identifies the compensation that will be paid to the representing real estate broker in the event a lease is eventually signed at that building. Problems exist in this area because there are often disagreements between the Landlord and the representing broker regarding the language in that commission agreement. By delivering the RFP to the Landlord before agreeing on the terms of the commission agreement, the Landlord has no obligation to enter into such an agreement and because of this, will usually be less than flexible when it comes to negotiating the terms of the commission agreement with the broker representing the Tenant. The representing brokers usually find themselves with agreements containing no late payment fee provisions and sometimes at commission amounts less that what was verbally agreed to.

Therefore, if a Tenant would deliver the request for proposal ONLY after receiving an acceptable commission agreement from the Landlord, the Tenant would end up with more favorable commission agreements. Additionally, if both the Tenant and Landlord came to agreement on the commission agreement early in the transaction, it would eliminate time wasted arguing as a result of miscommunication on the precise terms of that agreement (i.e., late fees, commission paid on rent abated, cancellation options, etc).

In step #2 the Landlord returns a proposal to the Tenant. However, Landlords have unique proposal merge documents for making proposals to prospective Tenants, with no two Landlords using the same document. Additionally, a Landlord may ignore certain information requested in the RFP or propose parameters that are not consistent with the RFP. For example, a Tenant may request a ten year lease term and the Landlord may propose a ten year, six month term. Additionally, the Tenant may request a construction allowance of $30.00 per square foot and the Landlord may only propose an allowance of $20.00 per square foot. This makes it very difficult to compare various building alternatives on an equal playing field.

Lastly, more times than not, the Landlord will fail to supply the commission agreement with the proposal. Instead, the Tenant is required to follow up via telephone to discuss why the agreement had not been delivered. As soon as a proposal is delivered to the tenant's representative, however, the tenant representative is required by law to present the proposal to the tenant, without any written agreement of how they will be compensated. This leaves the tenant's representative exposed to 1) potential lack of payment by the Landlord, 2) potential payment of commissions in amounts less than what was orally agreed to or 3) potential late payment of commissions without any adequate late payment fees or compensation for the time value of money.

In step #3 above, it is common for the Tenant and Landlord to verbally reach an agreement in concept before establishing other crucial elements of the transaction, such as the Tenant's financial information, the amount of the security deposit and the wording in the lease document, leading to decreased leverage in negotiating the those terms.

In steps #4, #5 and #6 above, receiving financial information and establishing the security for the lease is left until after the proposal is delivered, and most times after the general terms of the lease are established. In many cases, the Landlord might offer a different proposal if they knew the financial strength of the potential tenant (good or bad). Additionally, the Tenant is left in a poor negotiating position if they identify their willingness to move to a particular building before the Landlord identifies the required security. Sometimes the Tenant might even execute a letter of intent before establishing the actual security that will be required by the Landlord.

In #7 above, the letter of intent is typically entered into before the Landlord presents the lease to the Tenant, and certainly before the Landlord identifies which terms they are willing to modify at Tenant's request. Again, this leaves the Tenant in a negotiating position of weakness because they are asking for modifications to the lease document after they have agreed to the basic terms of the lease.

Although the prior art process described above is used to facilitate billions of dollars in annual leases, many steps in the current process would be more effective and efficient from the user's standpoint if 1) the order of the process was changed to collect more comprehensive information and on a more timely basis, and 2) there was standardized “request for proposal” utilizing web-based functions that forced landlords to not only present proposals the way tenants/tenants' representatives require it, but in a similar format so that each proposal can be evaluated side by side. This would expedite the report generation process by enabling the user to download the supplied information directly into a database/lease analysis program.

While systems for negotiating leases using a computer network have been developed, they fail to address the shortcomings of the process described above. For example, U.S. Pat. No. 7,024,397 to Donahue refers to an online system and method of negotiating a lease. It allows a potential lessor and lessee to walk through different terms of a lease and negotiate each term, one by one. A system and method of collecting (or requesting) information so that decisions regarding negotiations can be made based on the most accurate and comprehensive information possible, however, is desirable, and the system of the Donahue patent does not provide this. Simply put, the Donahue patent is directed to a system of simply negotiating a lease, not collecting complete and accurate information so that effective and meaningful negotiations could subsequently be taken. In addition, the system of the Donahue patent is designed to facilitate the actual negotiations with a single landlord. A system and method that facilitates negotiations with multiple landlords is desirable.

United States Patent Application Publication No. 2003/0004861 to Amend, et al. describes a system whose main function is to match a lessor with available space with a lessee in need for that space. This publication involves a process that may be taken before the request for proposal described herein is taken. While it does include a mechanism for RFP and proposal exchange between lessor and lessee, the system uses a traditional approach that is already utilized by a large percentage of the real estate community and described above.

### BRIEF DESCRIPTION OF THE DRAWINGS

FIG. 1 is a schematic illustrating an embodiment of the system of the present invention;

FIG. 2 is a flow chart illustrating an embodiment of the method of the present invention;

FIGS. 3-24 and 26 are screen prints of displays provided by the system and method of FIGS. 1 and 2;

FIGS. 25A and 25B illustrate a lease proposal generated by the system and method of FIGS. 1 and 2;

FIG. 27 is a Financial Summary report generated by the system and method of FIGS. 1 and 2;

FIG. 28 is a Financial Summary Comparison report generated by the system and method of FIGS. 1 and 2;

FIG. 29 is an Amenities Comparison report generated by the system and method of FIGS. 1 and 2;

FIG. 30 is a Legal Terms Comparison report generated by the system and method of FIGS. 1 and 2.

### DETAILED DESCRIPTION OF EMBODIMENTS

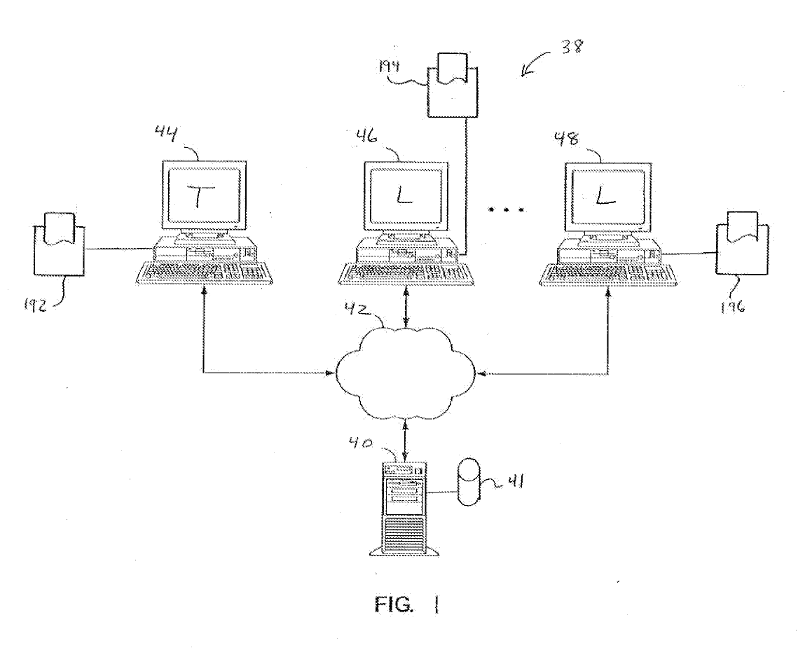

An embodiment of the system of the present invention is indicated in general at 38 in FIG. 1. The system includes a server 40 which hosts a website and associated software with the functionality as described below. The server 40 also includes databases (as indicated at 41 in FIG. 1) and other memory storage with the functionality as described below. A number of workstations communicate with the server 40 via a network such as the Internet 42. In the following description, the tenant and/or tenant's agent or representative are collectively and individually referred to as the “tenant” while the landlord and/or landlord's agent or representative are collectively and individually referred to as the “landlord.” The workstations may include a tenant's workstation 44 and landlord workstations 46 through 48. The server preferably includes four processors, three hard drives configured for RAID 5, a tape backup unit and a file storage module. The server also features multiple connections to the Internet and redundant power sources.

The system of FIG. 1 facilitates the exchange of information between a landlord and tenant (and more commonly than not, a landlord's representative and a tenant's representative) when a tenant is interested in potentially leasing commercial real estate from a landlord. Although this example shows an interchange of information relative to the office sector of commercial real estate, the invention can be easily modified to include industrial and retail real estate as well.

Typically, when a tenant is searching for office space, either because their lease is expiring or because they are simply looking for new office space, a tenant, either alone or with the assistance of a real estate agent, will look at buildings that generally meet their requirements. These requirements may include location, price, building amenities and the like. It is not uncommon for the tenant to visit many buildings on what is called a ‘building tour’ in the industry. Additionally, although there is no limit to the number of buildings that a tenant might consider on the building tour, it is standard practice to solicit bids from three to five buildings. The solicitation of a landlord's bid is usually covered in a request for proposal from the tenant or proposal exchange from the landlord and tenant. In order for a tenant to responsibly consider the advantages and disadvantages between the competing buildings, a myriad of information must be collected.

The system of FIG. 1 follows predetermined phases and steps using a computer and web based software program that 1) assists all parties in more efficiently completing the transfer of information, 2) allows the tenant (or tenant's representative) to collect more comprehensive information than the current system in real estate provides and 3) provides the tenant with better leverage for negotiations that typically take place after competing buildings' information has been assessed.

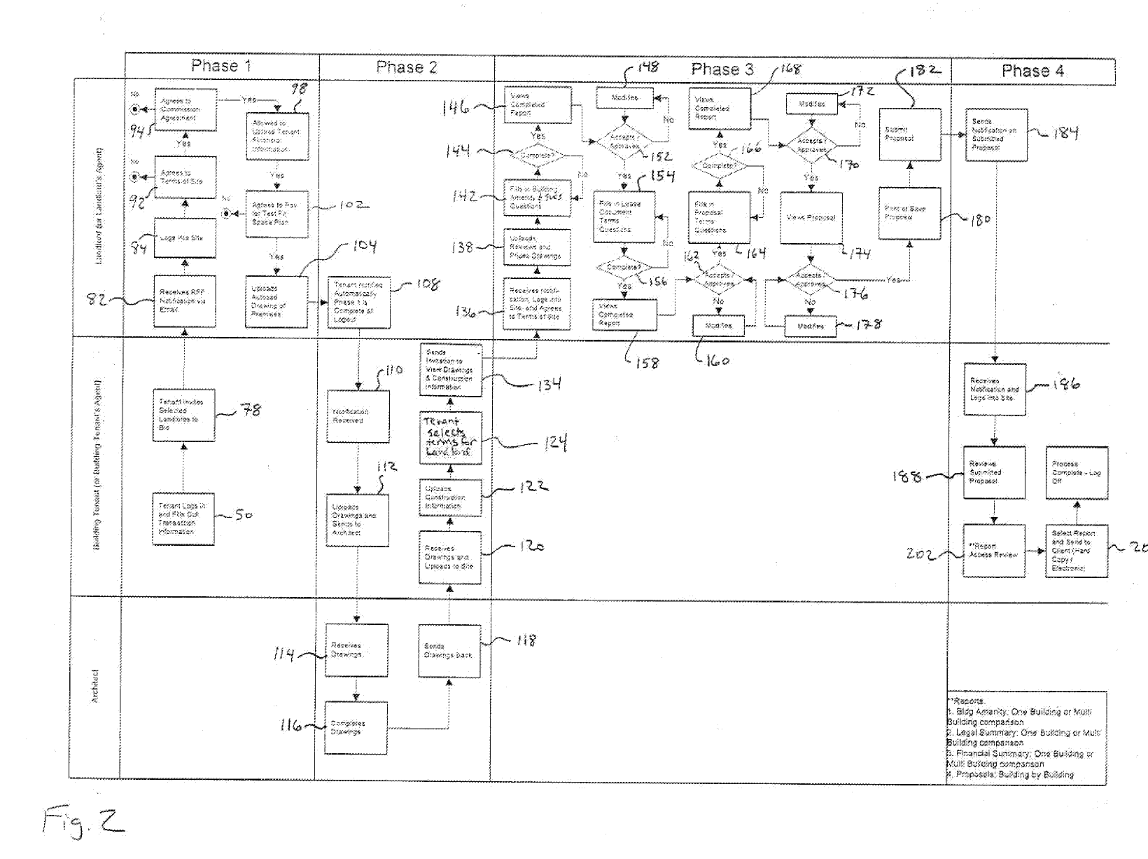

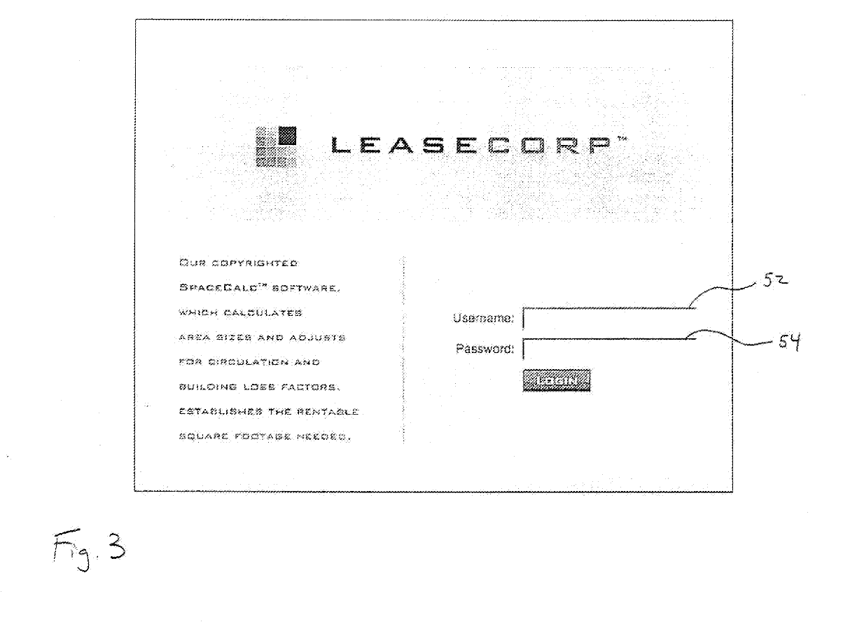

There are three phases in the method performed by the system of FIG. 1. The steps included in each phase are detailed below and in FIG. 2. In addition, FIGS. 3-26 illustrate examples of screens that are presented to users by the system of FIG. 1.

As illustrated at 50 in FIG. 2, an embodiment of the method of the invention starts with the tenant logging in and setting up information on the system of FIG. 1 so that electronic requests can be delivered. All of the information is included in a merge document that the landlord will eventually agree to before submitting information. The following steps 1-5 of phase 1 are included in block 50 of FIG. 2.

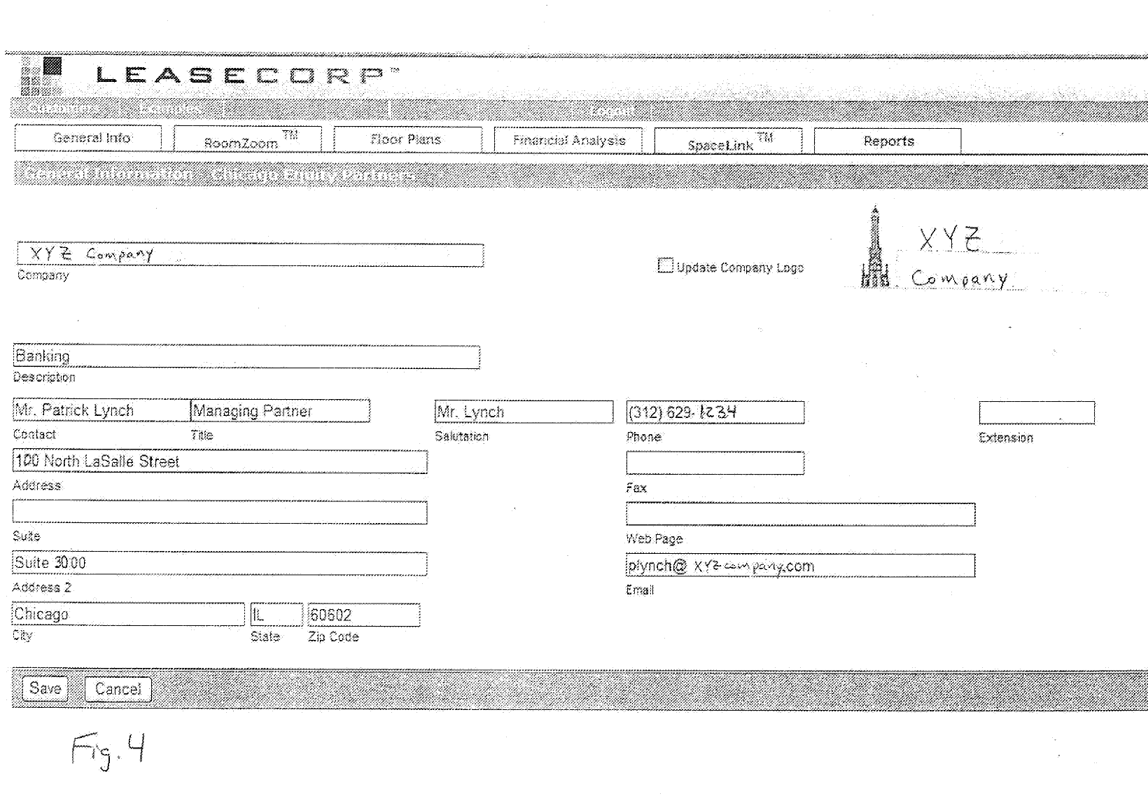

Phase 1, Step 1: A login screen, such as the one illustrated in FIG. 3, is displayed to the tenant via workstation 44 when he or she accesses the system website on server 40. The tenant enters a user name 52 and a password 54. If he user is a tenant's agent, he or she next accesses the screen of FIG. 4, via workstation 44, where he or she selects the tenant client from a list of existing tenant clients, or, if it is a new tenant client, he or she sets up a new tenant client account with certain requested information, including, but not limited to: tenant client name, address, contact name, email address, industry, remote locations, etc. If the user is an actual tenant, the tenant merely selects the tenant's name and updates the associated information if necessary.

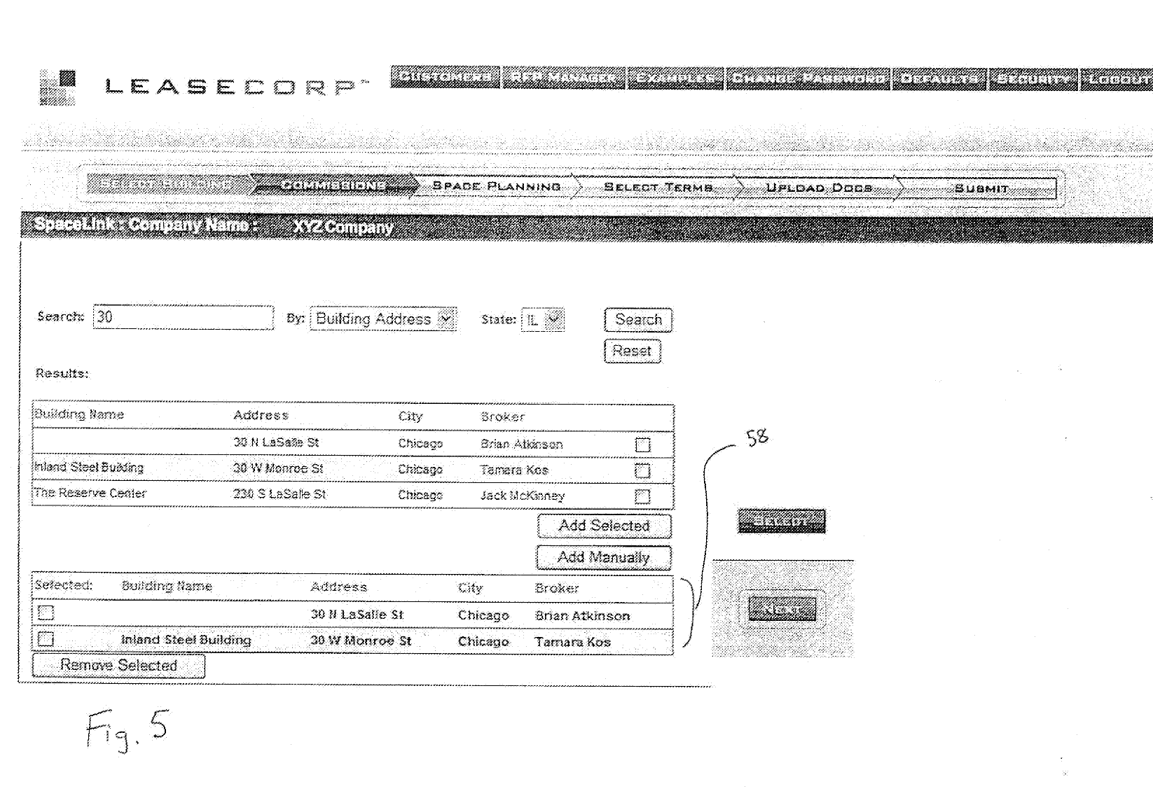

Phase 1, Step 2: The tenant next selects the buildings that he or she would like to request proposals from. As an example, the screen of FIG. 5 may be used for this purpose. A database of the buildings is preferably present in server 40 (FIG. 1) such that the tenant can search and select the buildings, with corresponding building information, and avoid having to enter the information. This results in a list of buildings selected, as indicated at 58 in FIG. 5. If the subject building is not in the database, the Tenant may enter the critical information (broker, building, address, email address, etc) manually via workstation 44 (FIG. 1). In this step, building information entered manually can also be saved to the database for future searches so that it does not have to be entered again.

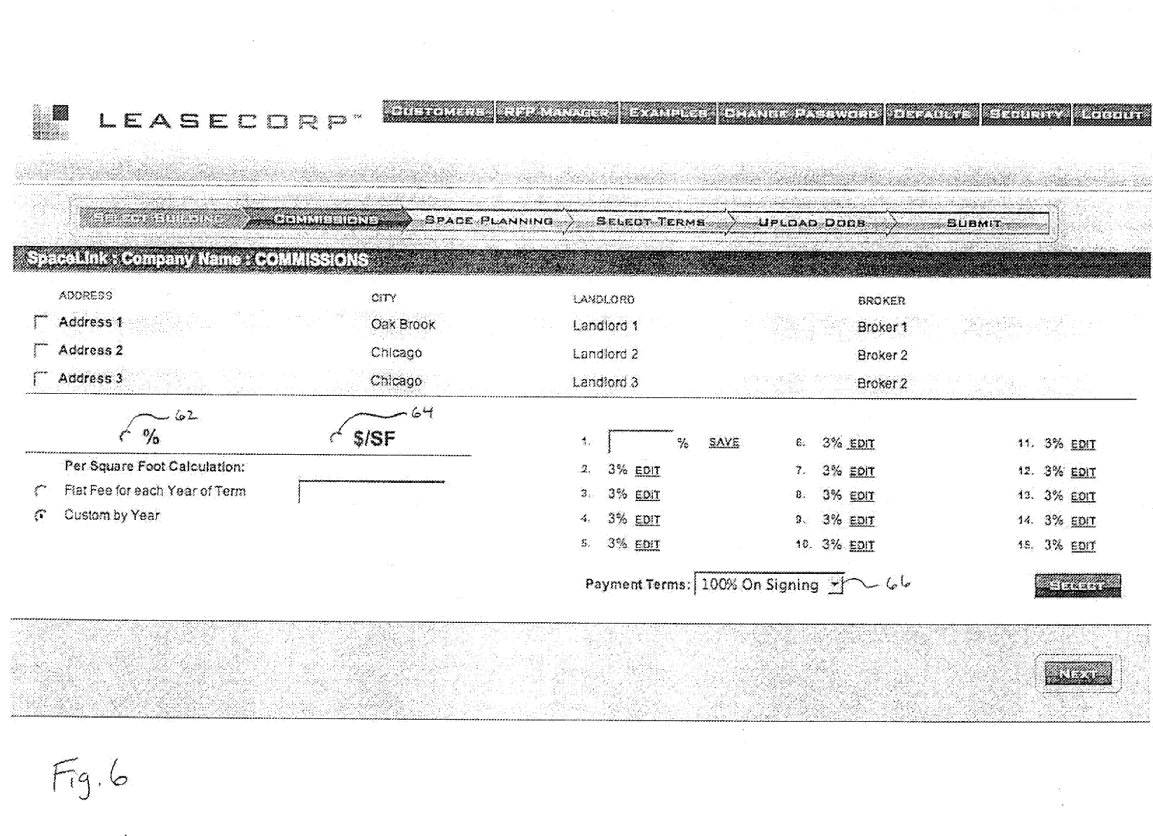

Phase 1, Step 3: The tenant next selects the commission structure that each of the competing buildings are offering. It is typical for the landlord to identify to the tenant any real estate commission that might be offered if a successful lease is entered into between the parties. This may occur, for example, during the “building tour” described above. FIG. 6 shows a screen that allows the tenant to select buildings one by one (or all at once if all the buildings have the same commission structure) and identify the commission structure for that building. As typical in the real estate industry, the commissions are either offered on a percentage of rent (usually either on the net or gross rental amounts), in which case field 62 of the screen of FIG. 6 is selected by the tenant, or based on an amount per square foot, in which case field 64 of the screen of FIG. 6 is selected. The tenant will select the options for that particular building and also select the payment terms that the landlord is offering, via pull-down menu 66. It is typical that the landlord will either pay the commissions 1) on lease signing, 2) 50% on lease signing and 50% on occupancy or 3) 100% on occupancy. Pull-down menu 66 allows the tenant to select one of these options.

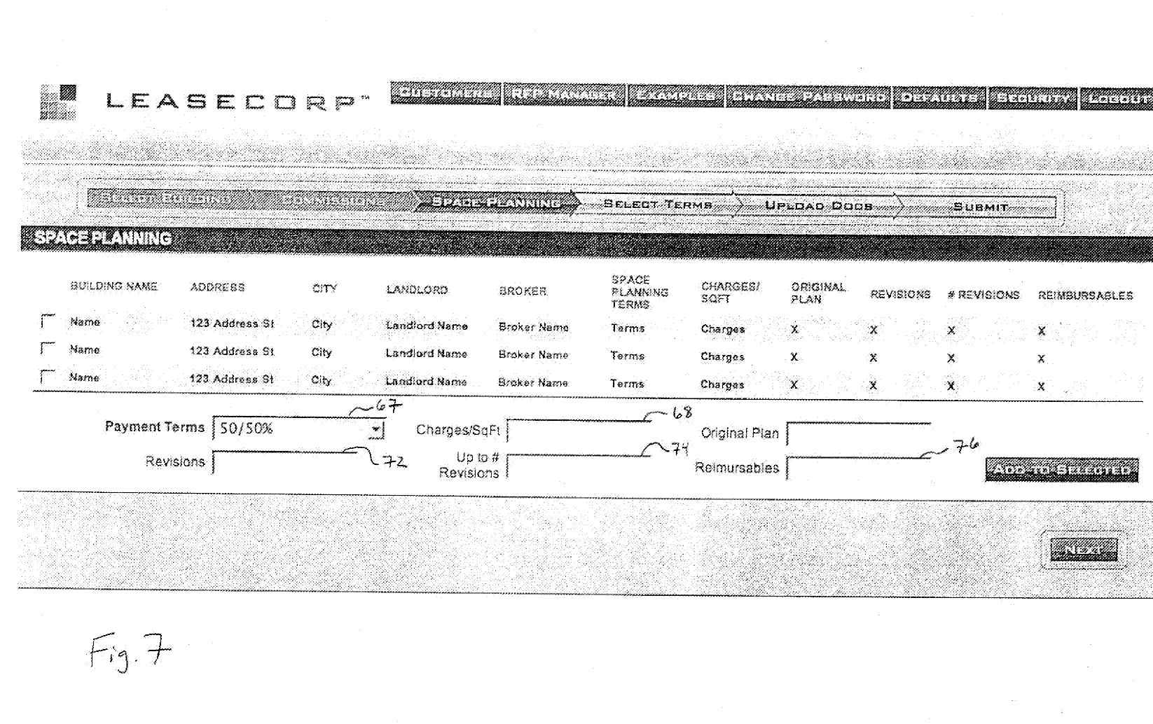

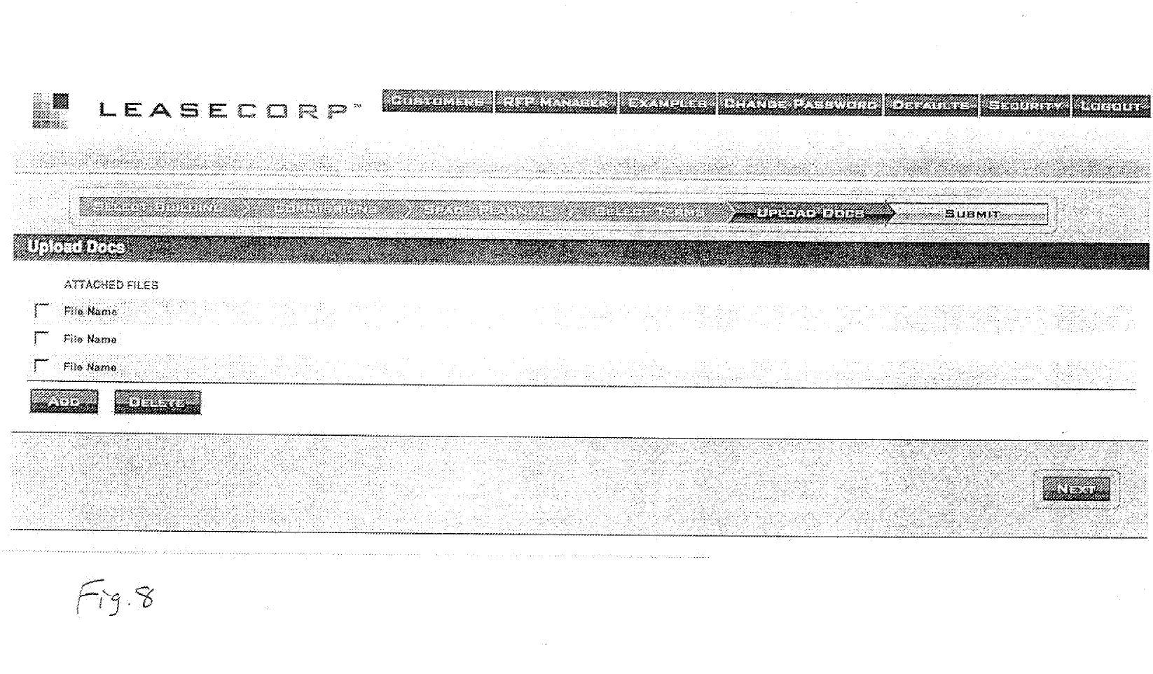

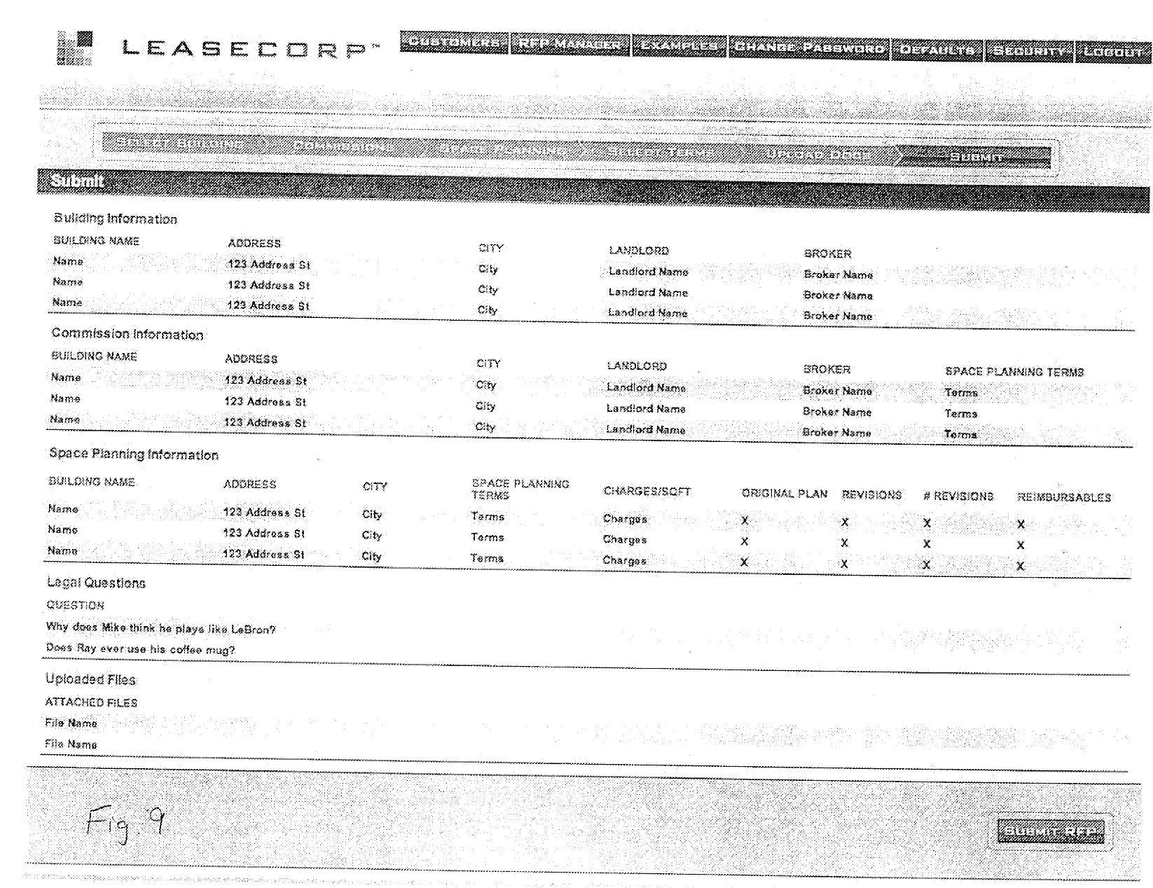

Phase 1, Step 4: Next, the tenant selects the fee structure for space planning using the screen of FIG. 7. In most cases, landlords are willing to provide free space planning for potential tenants so the tenant may see how their space will lay out in the subject building. Additionally, most real estate companies do not offer space planning services so this step may not be required by some parties. However, some real estate companies offer in-house space planning so there is a need for the landlord to agree to pay for these services. Much like the tenant filled out the commission structure in the previous step, the tenant also fills out the fee structure for space planning services.

With reference to FIG. 7, typically, the different components of space planning charges will be: the charges per foot for the initial space plan, entered in field 68, the charges per square foot for revisions, entered in field 72, the number of revisions the landlord is willing to pay for, entered in field 74, and the limit the landlord is willing to pay for “reimbursables” (printing, messenger fees, travel time, etc). The screen allows the tenant to identify all of these options and charges. All of the information will be included in a merge document that the landlord will eventually agree to before submitting information.

Phase 1, Step 5: Next, by using the screen of FIG. 8, the tenant attaches any documents that the landlord may need to prepare a proposal for the tenant. It is typical in real estate transactions for the landlord to identify aspects of both the transaction and the tenant so that they may determine the terms of the proposal they are willing to offer. For example, the financial creditworthiness of tenant affects the risk associated with the transaction and the risk in a transaction affects how aggressive a landlord is willing to get with their terms. Additionally, the amount of construction that needs to be completed for tenant's occupancy also affects the rental rate because those costs are typically amortized over the lease term. In such, it is important that the landlord has a both the tenant's financial information and a clear description of the necessary construction so that the transaction risk and landlord's up front costs can be assessed. Step 5 allows the tenant to upload such financial information and construction requirements.

Although a space plan would not typically be delivered at this point (because it would not have been prepared yet), the tenant has an option to upload an electronic version of the tenant's space plan at a later point in the transaction using the same upload mechanism.

Phase 1, Step 6: Next, the tenant reviews a summary sheet screen, such as the one illustrated in FIG. 9, listing all of the buildings selected and associated information, before sending the requests for proposals. In this step, the tenant views all information relative to the request for proposals they are about to send to landlords. This includes the commission structure, the space planning fees, the terms and options sought in the proposal and any documents that the tenant wishes to send to each landlord for consideration.

Provided all information on the summary sheet screen (FIG. 9) is correct, the tenant selects the “Send RFP” option, as illustrated by block 78 in FIG. 2. If the information on the summary sheet screen is not correct, the tenant moves back in the program to correct any mistakes that the tenant might see on the summary review sheet.

Once the “Send RFP” button is selected, email notices are sent to of each of the landlords selected (78 in FIG. 2), giving them a link to the site where proposals may be filled out and instructions for entering the site (i.e., log in name and password).

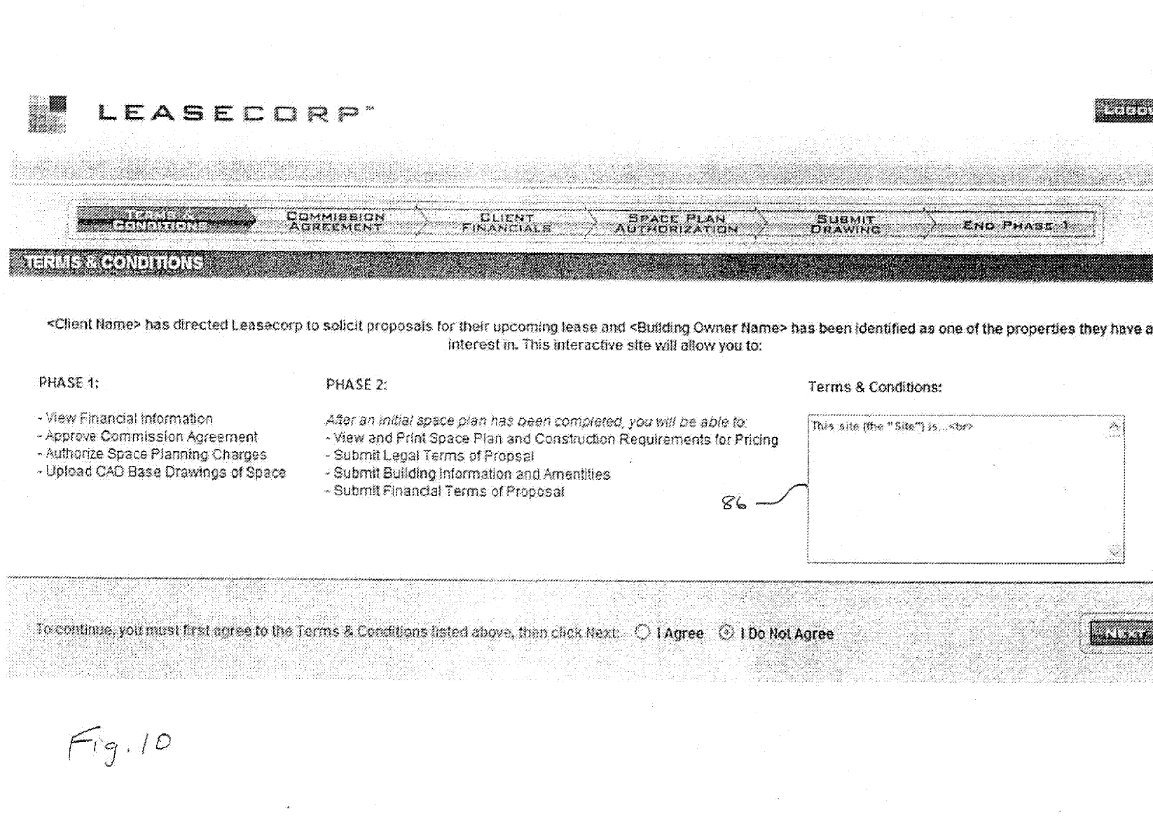

Phase 1, Step 7: As indicated at 82 in FIG. 2, a landlord receives e-mail notification of the request for proposal, via a landlord workstation, such as workstation 46 of FIG. 1, and is directed to the site with a unique user log in name and password. As indicated at 84 in FIG. 2, the landlord may then log onto the site on server 40 (FIG. 1) using the landlord workstation 46. Upon logging into the site, the screen of FIG. 10 is displayed which lists terms and conditions 86 for using the site and selections to accept or not accept the terms and conditions. The terms and conditions may include, but are not limited to, such items as: confirmation that the agreements they enter into on the site are legally binding, confirmation that they have the authority to enter into such agreements, that the information they collect during the process is confidential as it relates to the tenant and tenant's financial information, that they agree not to allow unauthorized users into the site or give their user name and password to anyone without the prior written authorization of the system administrator, and such other items that protect the tenant and administrator and ensure the information collected is accurate, confidential and legally binding.

As illustrated at 92 in FIG. 2, the landlord must agree to the terms and conditions before he or she is permitted to continue progressing through the site by moving to Phase 1, Step 8 illustrated at 94 in FIG. 2.

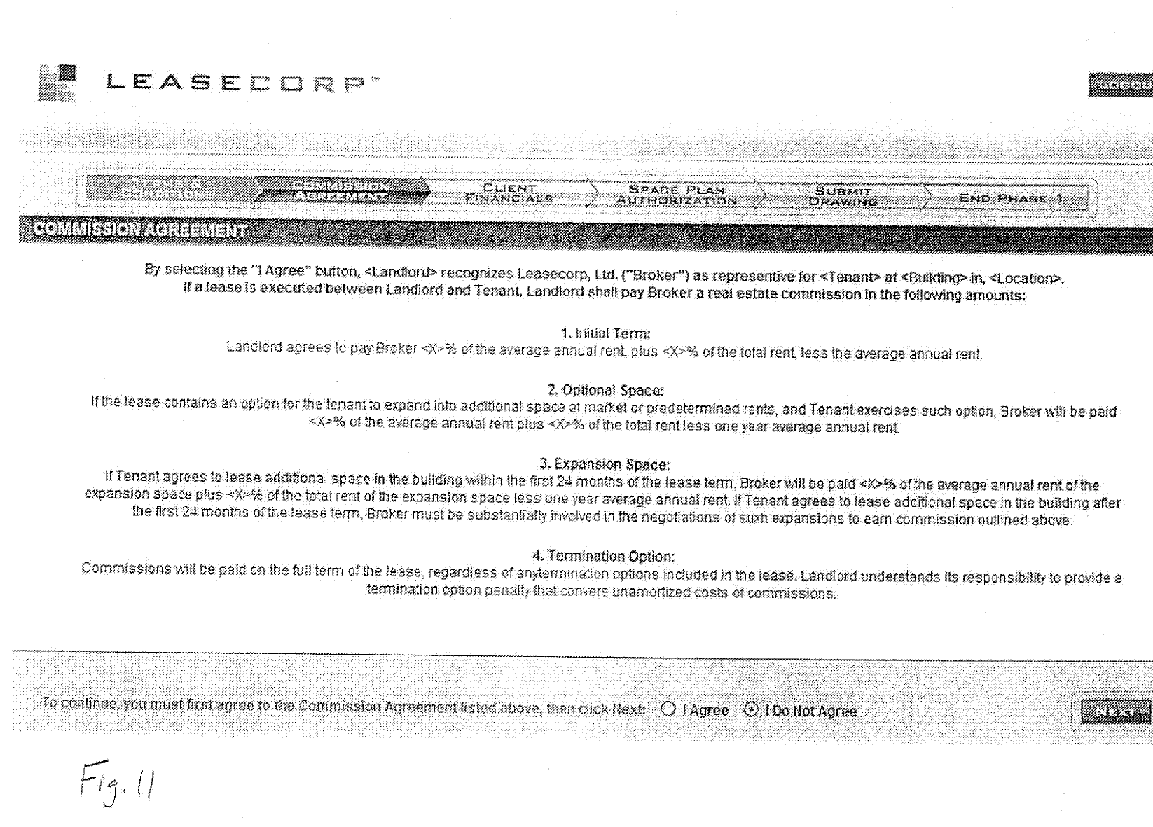

Phase 1, Step 8: During this step, the landlord must agree to the commission agreement to progress further in the process. Based on the information entered by the tenant in Phase 1, Step 2, a commission agreement, presented by the screen of FIG. 11, is generated using merge fields that identifies the terms and conditions under which a commission will be paid to the tenant or tenant's representative by the landlord. If the landlord wishes, they may print the document for approval (if needed) before continuing. However, until the landlord agrees to the commission agreement, they may not move to Phase 1, Step 9, which is illustrated at 98 in FIG. 2.

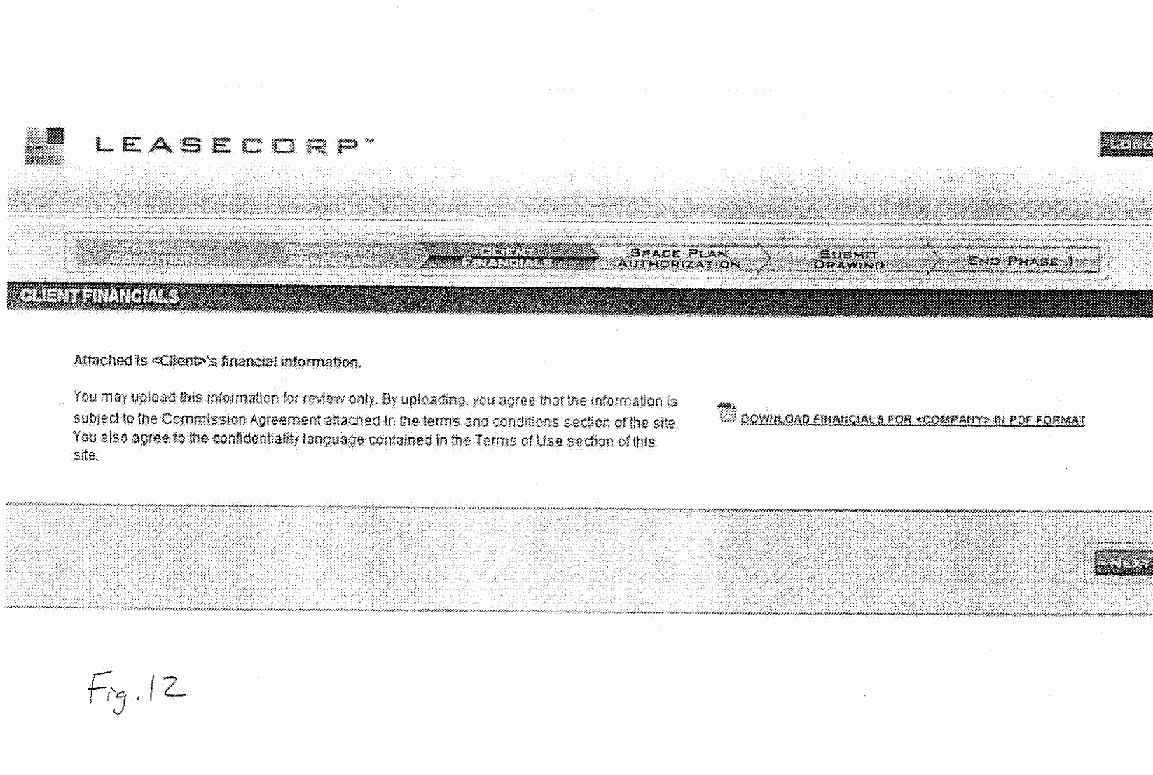

Phase 1, Step 9: During this step, illustrated at 98 in FIG. 2, the landlord downloads the tenant's financial information using the screen of FIG. 12. Unlike most commercial real estate transactions where the landlord is asked to present a proposal prior to viewing the proposed tenant's financial information, the landlord is able to download and view the tenant's financial information prior to committing to space planning fees or any substantial amount of time involvement. From the landlord's standpoint, this is a substantial improvement over prior art systems and methods as it allows the landlord to potentially eliminate tenants that they may not want to consider as a tenant in their building because of risk identified in the tenant's financial information, thus avoiding space planning fees that the landlord may have otherwise approved.

From the tenant's standpoint, the feature also saves time in instances where the landlord opts not to entertain a proposal because of negative risk, a stance that may not otherwise be identified until much time and negotiating efforts have been invested. In cases where the tenant's financial information is strong, the feature also benefits the tenant because the landlord will most likely get more aggressive in leasing to low risk tenants, thus increasing the negotiating position of the tenant.

As noted previously, the common practice in the real estate industry is to withhold the tenant financial information (and subsequent security requirement) until the landlord and tenant agree “in concept” to the general terms of the pending lease. However, this is an ineffective method of negotiating because it leaves a major term unidentified until after the parties agree in concept. By providing the financial information earlier in the transaction, the landlord has no excuse for not identifying the security (security deposit or letter of credit) that will be required for a tenant's occupancy. The tenant can then include the amount of security required by competing buildings as part of the decision making process and include negotiations of the security requirements before agreeing in concept to the other terms of the proposal. The feature also avoids tenant time wasted pursuing buildings that, had the security deposit been identified earlier in the proposal process, would not otherwise be a consideration for the tenant.

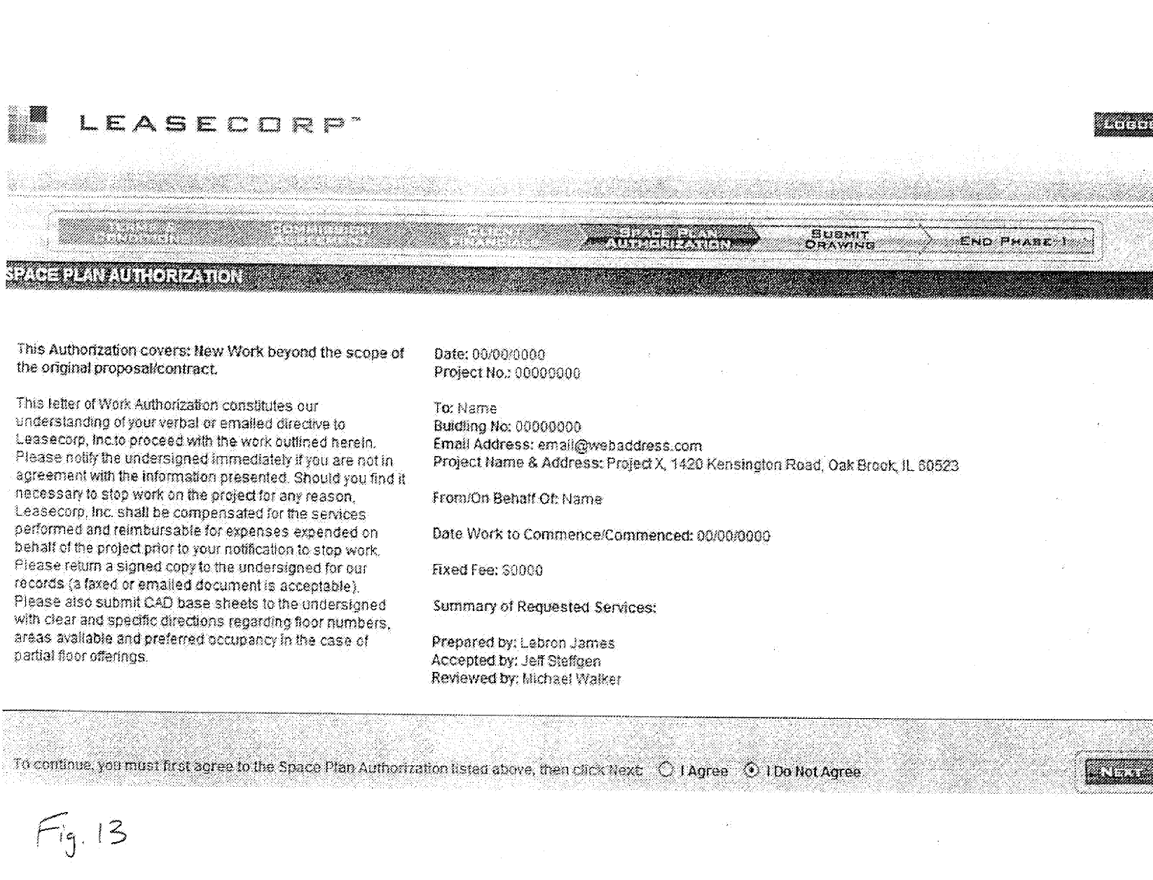

Phase 1, Step 10: During the next step, indicated at 102 in FIG. 2, the landlord must agree to space planning charges to continue with the process. Based on the information entered by the tenant in Phase 1, Step 4, a space planning fee agreement, presented by the screen of FIG. 13, is generated using merge fields and identifies the terms and conditions for space planning and architectural work that will be paid to the tenant by the landlord. If the landlord wishes, they may print the document for approval (if needed) before continuing. However, until the landlord agrees to the commission agreement, they may not move to Phase 1, Step 11, illustrated at 104 in FIG. 2.

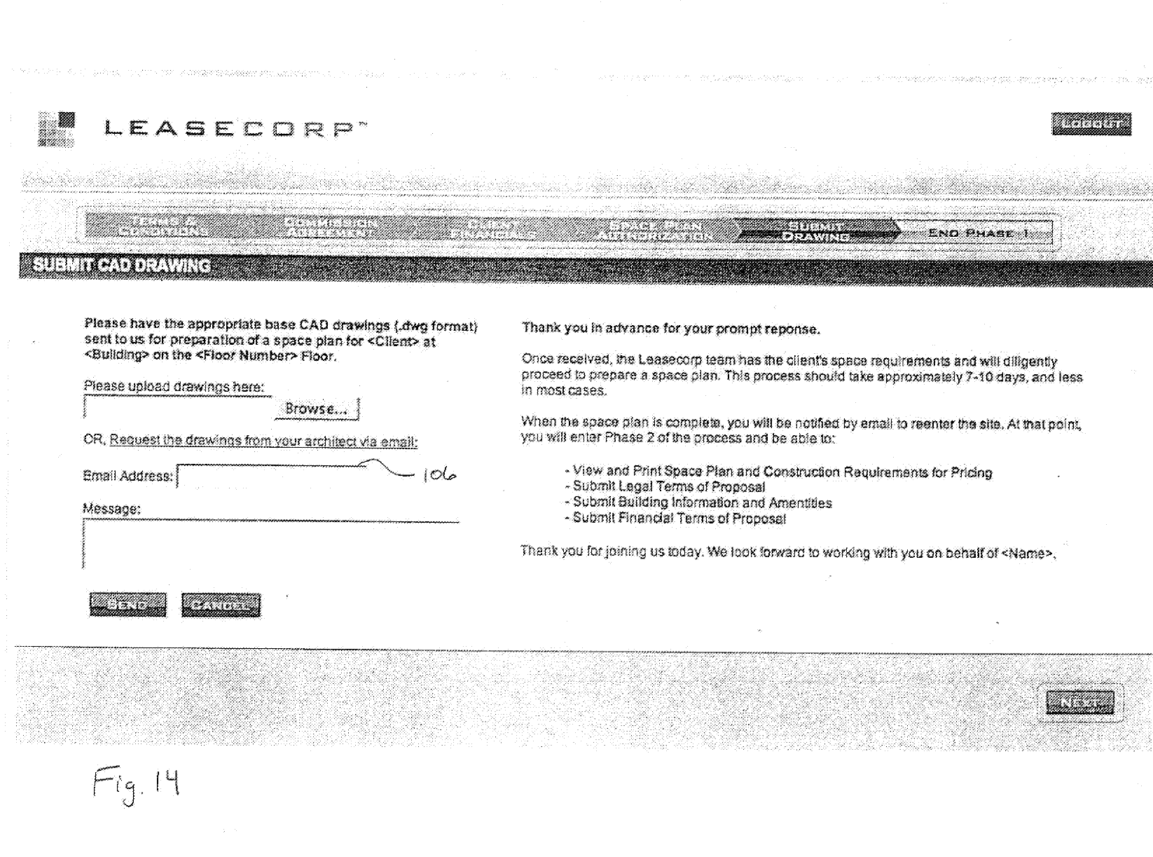

Phase 1, Step 11: During this phase, the landlord uses the screen of FIG. 14 to upload an electronic version of the building area that contains the desired area to be leased, which preferably is in .dwg (AutoCAD extension) format, but may also be in other acceptable electronic forms that an architect or space planner can modify to the tenant's desired configuration. In instances where the file is kept by the landlord's architect and not the landlord, the system, as illustrated at 106 in FIG. 14, allows the landlord to email a request to their architect. The automatic email pop up may be set up such that the email address and contact information of the end user (typically the tenant's architect) will automatically be included in the email through a merge field that pulls information originally entered by the tenant.

Phase 2, Step 1: As illustrated at 108 and 110 in FIG. 2, the tenant is notified via e-mail sent to workstation 44 that the landlord has completed Phase 1 when the landlord logs off the site and server 40 (FIG. 1) via landlord workstation 46.

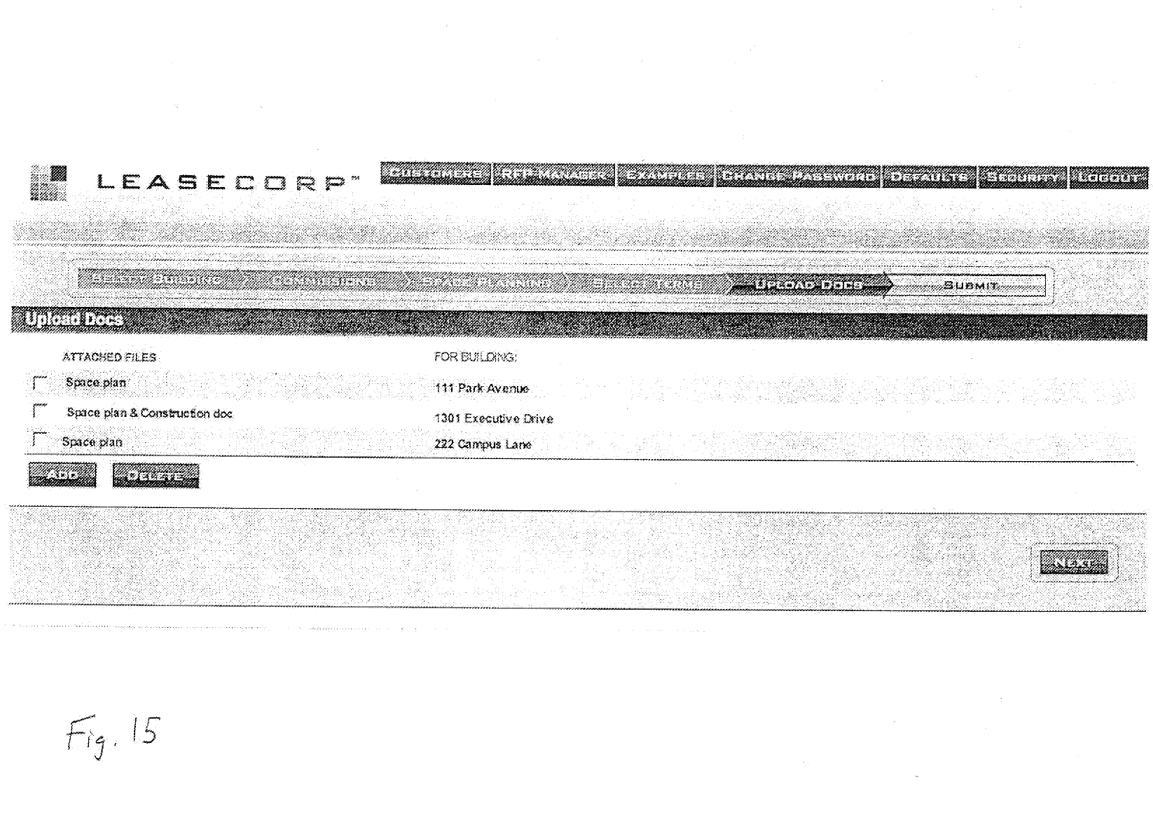

Phase 2, Step 2: During this step, which is illustrated at 112 in FIG. 2, the tenant prepares a space plan that incorporates the requirements of the tenant into the available space at the subject building. Alternatively, as illustrated by blocks 114, 116, 118 and 120 in FIG. 2, the tenant's architect may prepare the space plan. Once the space plan is prepared with the desired lay out for tenant's use, both the space plan and any additional notes required to solicit construction estimates for such work, as illustrated at block 122 in FIG. 2, can be uploaded via the screen of FIG. 15 so that they are available for download to the landlord.

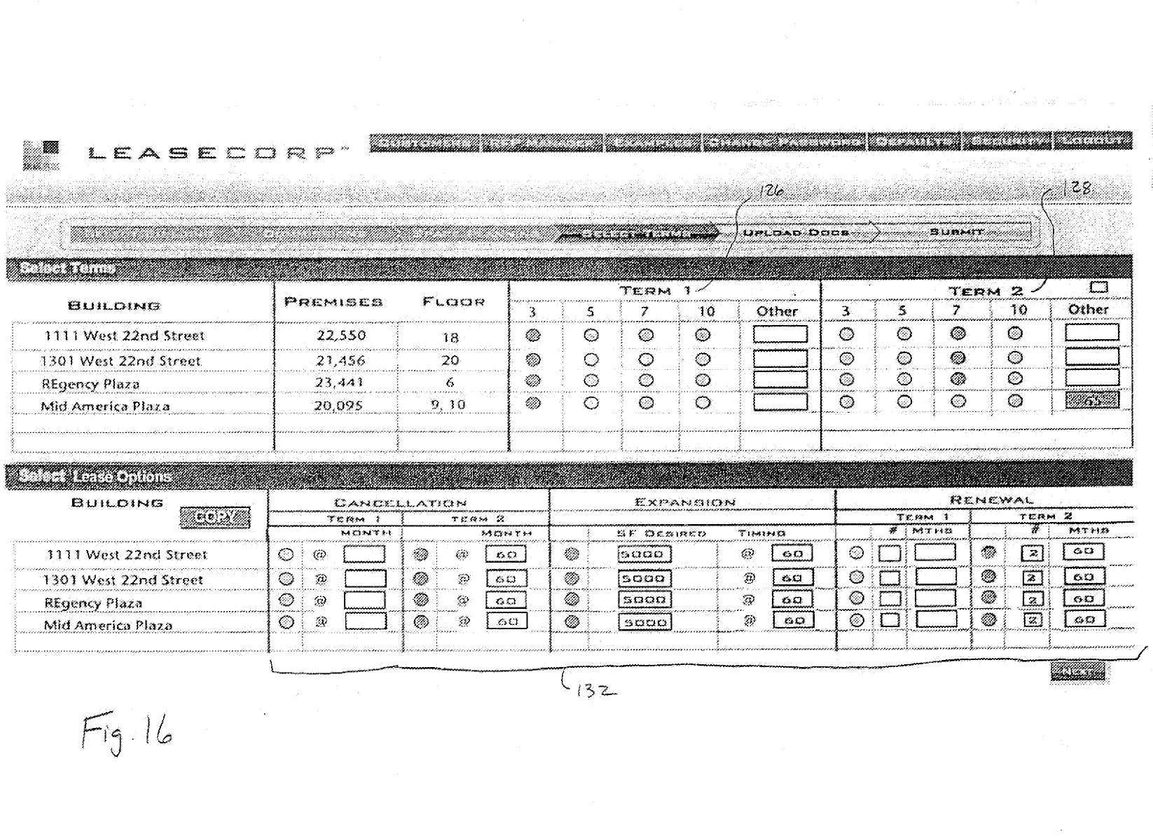

Phase 2, Step 3: As illustrated by block 124 in FIG. 2, the tenant next selects the terms that they would like the landlord to identify in their proposal via the screen of FIG. 16. In most cases, the tenant will request either one or two different lease term options, indicated at 126 and 128 in FIG. 16, for the landlord to propose terms on (for example, a three year proposal and a seven year proposal). In addition, the tenant may also ask the landlord to provide different options, 132 in FIG. 16, to be included in the lease. These options may include cancellation options, expansion options and/or renewal options. Lastly, the tenant will also want to identify how many square feet they have determined they need to lease (typically information that is gathered from the space plan that was prepared).

There are many items that the landlord is typically asked to address in their proposal. The tenant does not need to specify those options because they are asked of all landlords, regardless of the tenant or tenant's desired terms and options. Examples of these items include, but are not limited to: history of taxes for the building and projected taxes for the current year, history of operating expenses for the building and projected operating expenses for the current year, how utility charges for the building will be handled and whether they will be included in operating expenses or billed directly to the tenant, the occupancy level at which the landlord will be allowed to gross up operating expenses to reflect full occupancy and a myriad of lease questions regarding the landlord's position on various landlord and tenant rights contained in the lease.

Once completed, as indicated at block 134 in FIG. 2, the tenant sends an email to the landlord notifying them that the plans and specifications are ready and the landlord may continue with Phase 3 of the process.

Phase 3, Step 1: As indicated at block 136 in FIG. 2, the landlord receives e-mail notification via landlord workstation 46 (FIG. 1) that the space plans are available for download. The notification reminds the landlord of their user name and log in information. Upon entering the site on server 40 (FIG. 1) using the landlord workstation, the landlord must again agree to the terms of use of the site and will not be allowed to proceed until doing so.

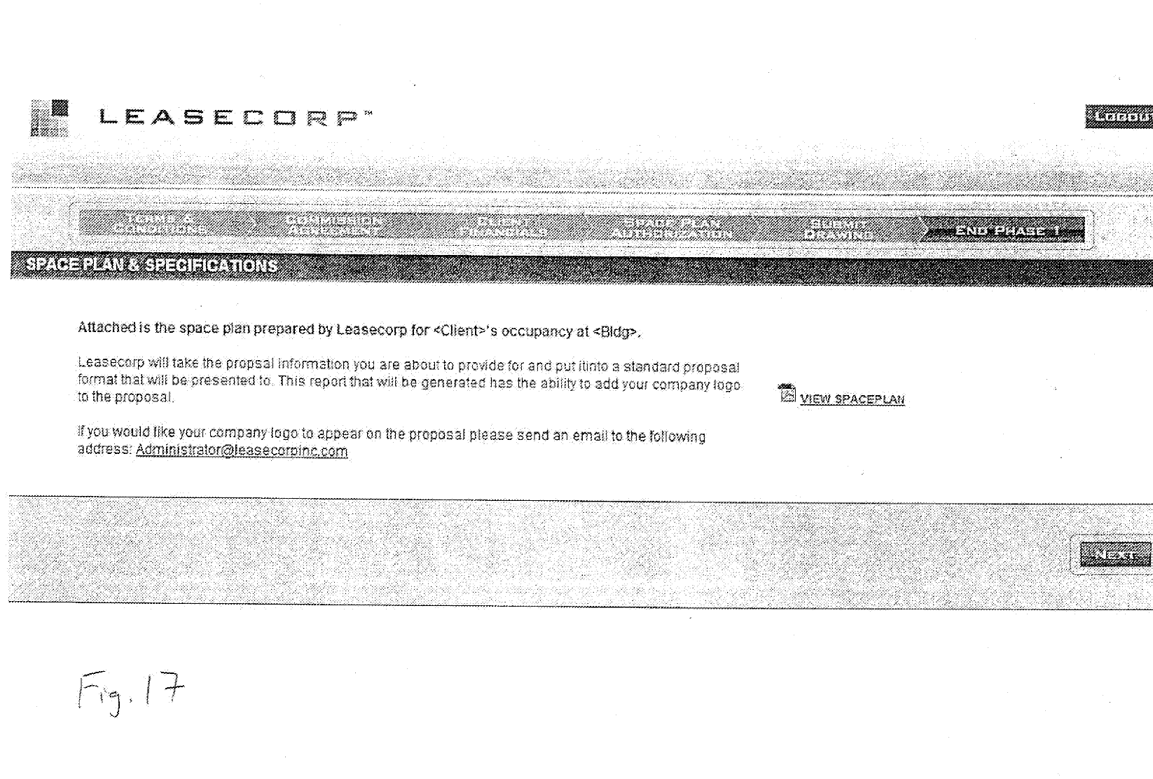

As indicated at block 138 in FIG. 2, once the landlord agrees to the terms of use, they will be allowed to download the space plan and any additional construction documentation uploaded by the tenant via the screen of FIG. 17. At this point, the user may elect to continue to Phase 4, Step 2, or leave the site in order to secure construction estimates for the work that needs to be completed for the tenant's occupancy.

Although the landlord will eventually need the construction estimate before completing the proposal process, a number of other items in the remainder of Phase 3 do not require this knowledge so 95% of Phase 3 can be completed before acquiring construction estimates. As such, it is the landlord's option to complete all of Phase 3 at once (upon receiving construction information) or in two steps: the majority while construction pricing is being secured and that last 5% once that pricing is actually in hand.

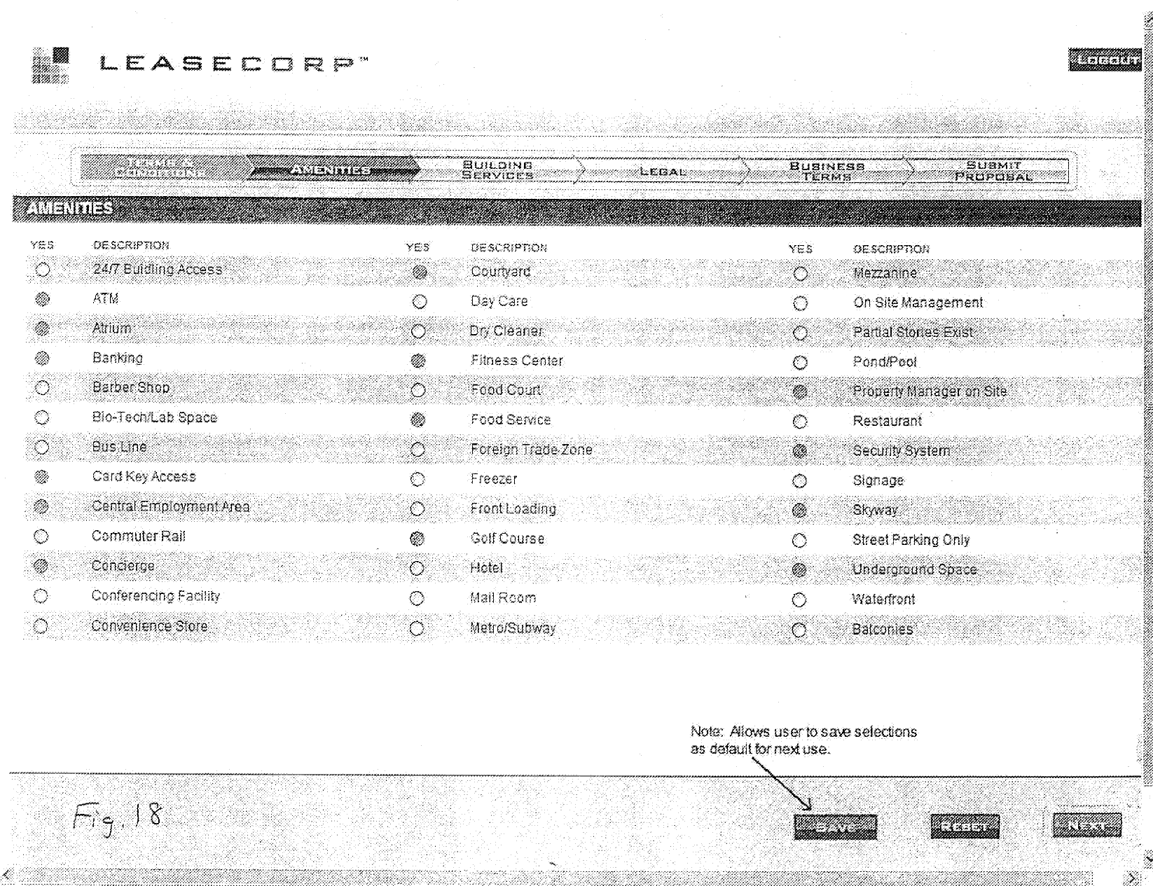

Phase 3, Step 2: As indicated at block 142 in FIG. 2, the landlord enters the amenities for the building via the screen of FIG. 18. The program identifies the amenities that may be available at typical office buildings and the landlord must indicate whether the subject building has that amenity or building service. Examples of amenities include, but are not limited to: covered parking, adjacent hotel, health club, food service, barber, convenient store, restaurant, ATM, banking on site, shopping, 24 hour manned security, after-hours key card access, on site management, and the like. A specific feature of the system allows the landlord to save the amenities the landlord has associated with the subject building so that subsequent proposals the landlord may prepare for other potential tenants will not require that the landlord fill out this screen again, only verify that nothing has changed since the last proposal the landlord submitted.

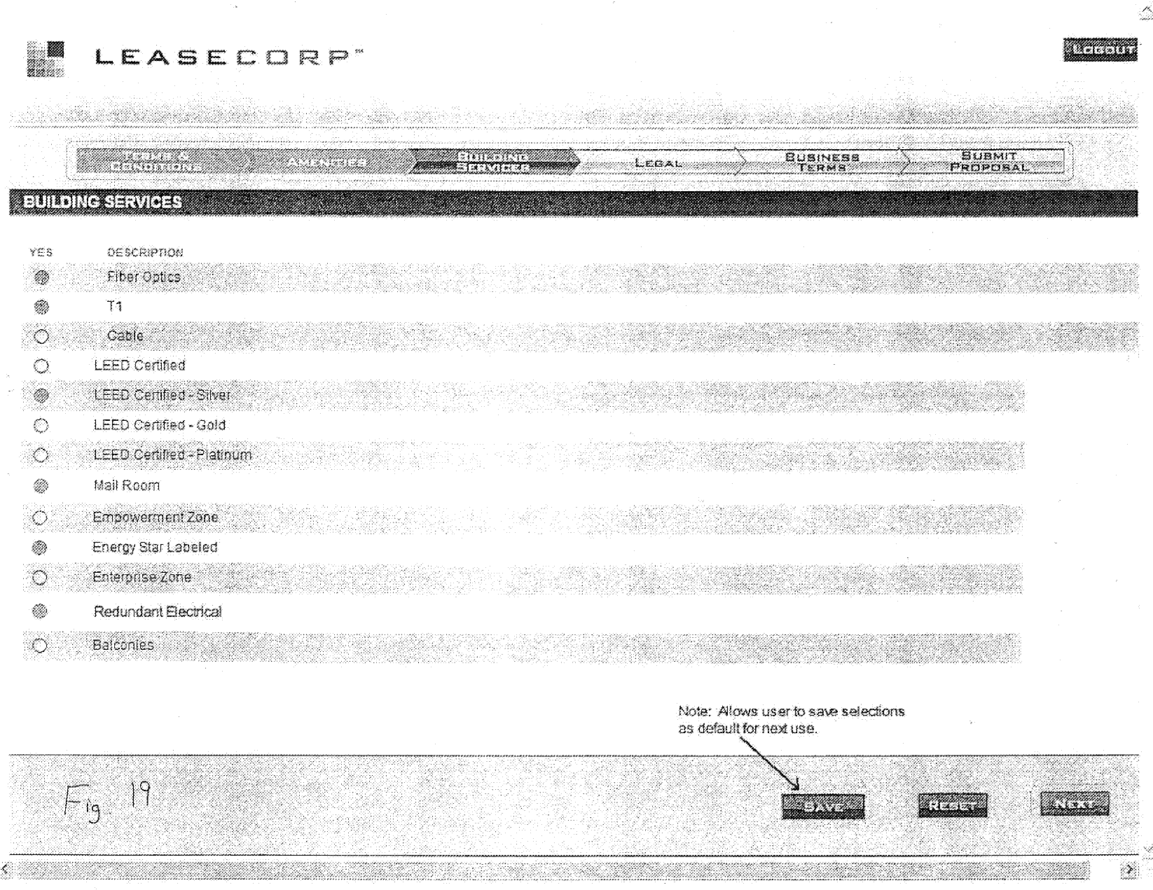

Phase 3, Step 3: During the step indicated by block 142 in FIG. 2, the landlord also enters the building services for the building via FIG. 19. The program identifies the building services that may be available at typical office buildings and the landlord must indicate whether the subject building has that building service. Examples of building services include, but are not limited to: high speed internet access, cable TV access, satellite TV access, fiber optics, back up generator, redundant electrical service (serviced by two separate electrical grids), chilled water for HVAC cooling, and the like. A specific feature of the system allows the landlord to save the building services the landlord has associated with the subject building so that subsequent proposals the landlord may prepare for other potential tenants will not require that the landlord fill out this screen again, only verify that nothing has changed since the last proposal the landlord submitted.

As indicated at 144 in FIG. 2, until the landlord identifies whether or not their building possesses the amenities and services listed on the screens of FIGS. 18 and 19, they may not continue with the process. Once the landlord completes the building amenity and services questions, as illustrated by blocks 146, 148 and 152, they have the opportunity to review their responses and modify them if necessary. Once this is completed, the landlord progresses to Phase 3, Step 4 of the process, indicated by block 154 of FIG. 2.

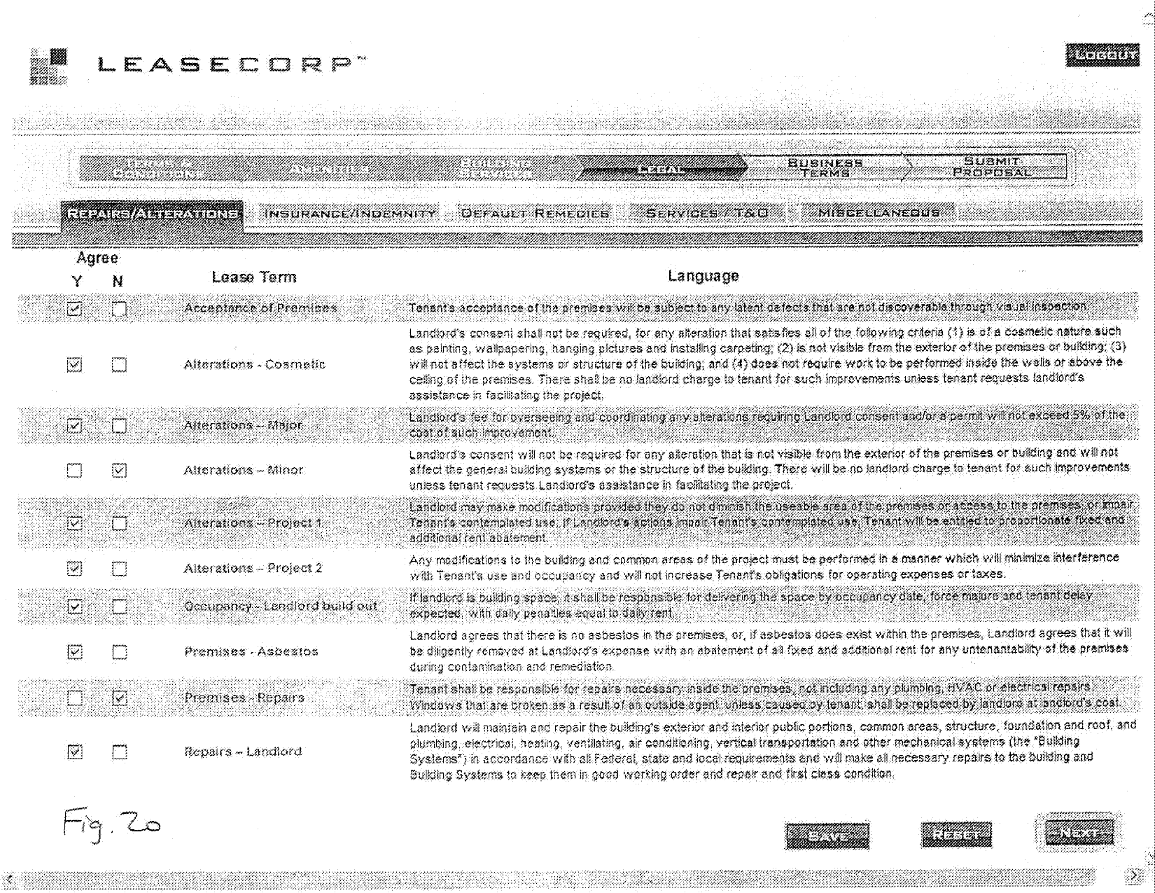

Phase 3, Step 4: During this step, the landlord answers questions regarding their lease document via the screen of FIG. 20. The prior art process adopted by the commercial real estate industry is to agree to the business terms of the lease and enter into a letter of intent before ever reviewing the lease document that the parties will enter into to solidify the transaction. The landlord's lease document, however, often contains unfavorable language from the tenant's perspective that must be negotiated by the parties. Often times, considerable expense is incurred by legal fees between the parties trying to agree on acceptable language. Moreover, because the business terms have already been agreed to, the tenant is in a position of weakness because they have already indicated that they want to move into the subject building (as evidenced by a letter of intent). The result is often a lease that 1) does not favor the tenant, 2) costs both sides considerable legal fees and 3) delays the transaction for the period in which the two sides were negotiating the points they did not agree on.

The screen of FIG. 20 requires the landlord to identify their stance on up to fifty lease terms. Although the actual language is not agreed to, the general concept of each lease point is. For example, a typical clause in most office leases requires the tenant to pay a penalty if the tenant retains possession of the premises after the lease has expired, which is commonly called the ‘Holdover Provision’. Moreover, it is common for the landlord to ask for a penalty of 200% of rent if the tenant holds over past the expiration of their lease. It is also common for that percentage to be “negotiated” between the legal representatives of both parties down to 150% or 175%. Although the actual language in the lease may vary slightly, the system simply makes the statement “Landlord agrees that the penalty for holding over shall be at 150%”. The landlord then has to either select “Yes” or “No” to each of any such questions, as illustrated in FIG. 20.

Since the landlord may not be authorized to answer these legal questions, another specific feature of the system allows the landlord to forward these questions to their attorney or legal counsel. In such instances, the system automatically generates a user name and password for the attorney so that they may enter the system and fill out the answers on behalf of the landlord. A specific feature of this system allows the landlord to save the legal responses they have given so that subsequent proposals the landlord may prepare for other potential tenants will not require that the landlord answer these questions again, only verify that their response has not changed since the last proposal the landlord submitted.

As indicated at 156 in FIG. 2, the landlord may not proceed with the process until they complete the lease terms questions. They then have the opportunity, as illustrated by blocks 158, 160 and 162, to review their responses and modify them if necessary. Once this is completed, the landlord progresses to Phase 3, Step 5 of the process, indicated by block 164 of FIG. 2.

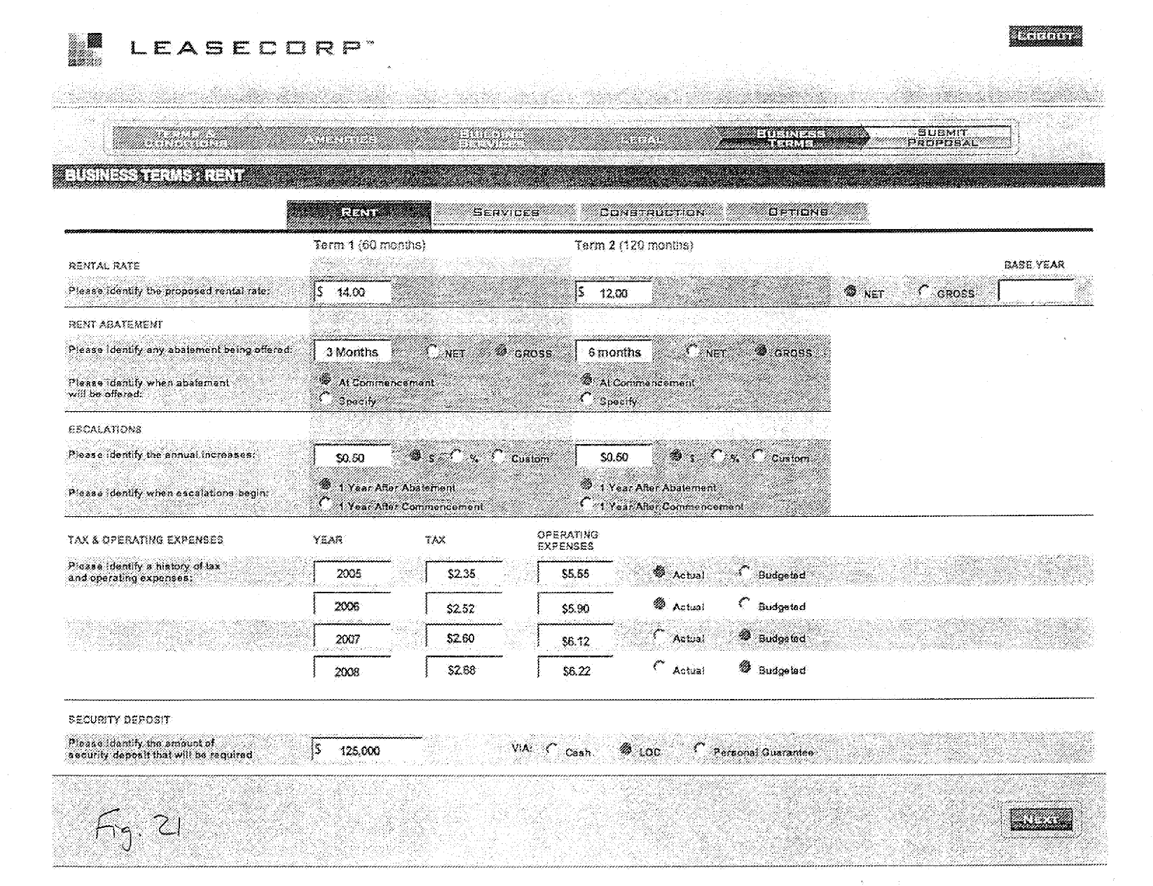

Phase 3, Step 5: Next, as illustrated by block 164 of FIG. 2, the landlord fills out the business terms of their proposal using the screens of FIGS. 21-24. At this point in the process, all information that is needed for a tenant to make an educated decision on where to lease office space has been supplied, with exception of the specific business terms. The system is designed specifically this way so incomplete proposals can not be delivered.

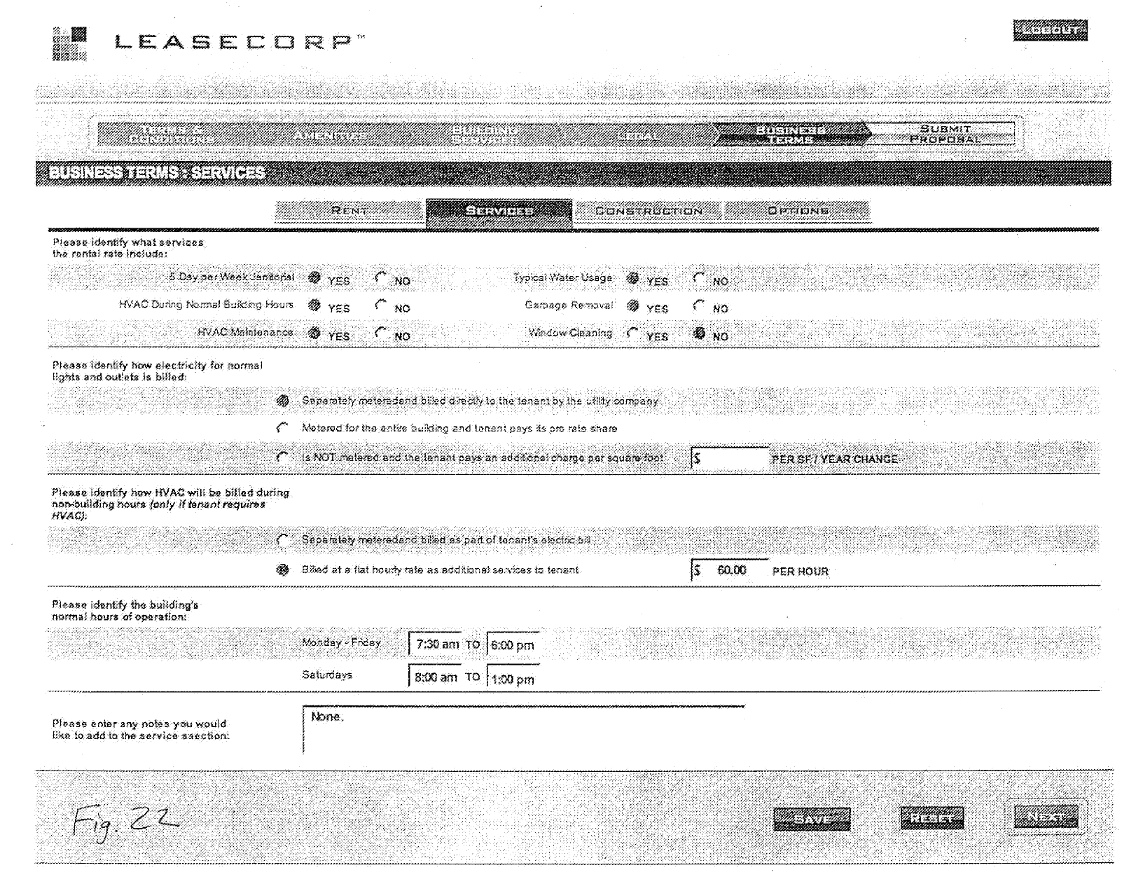

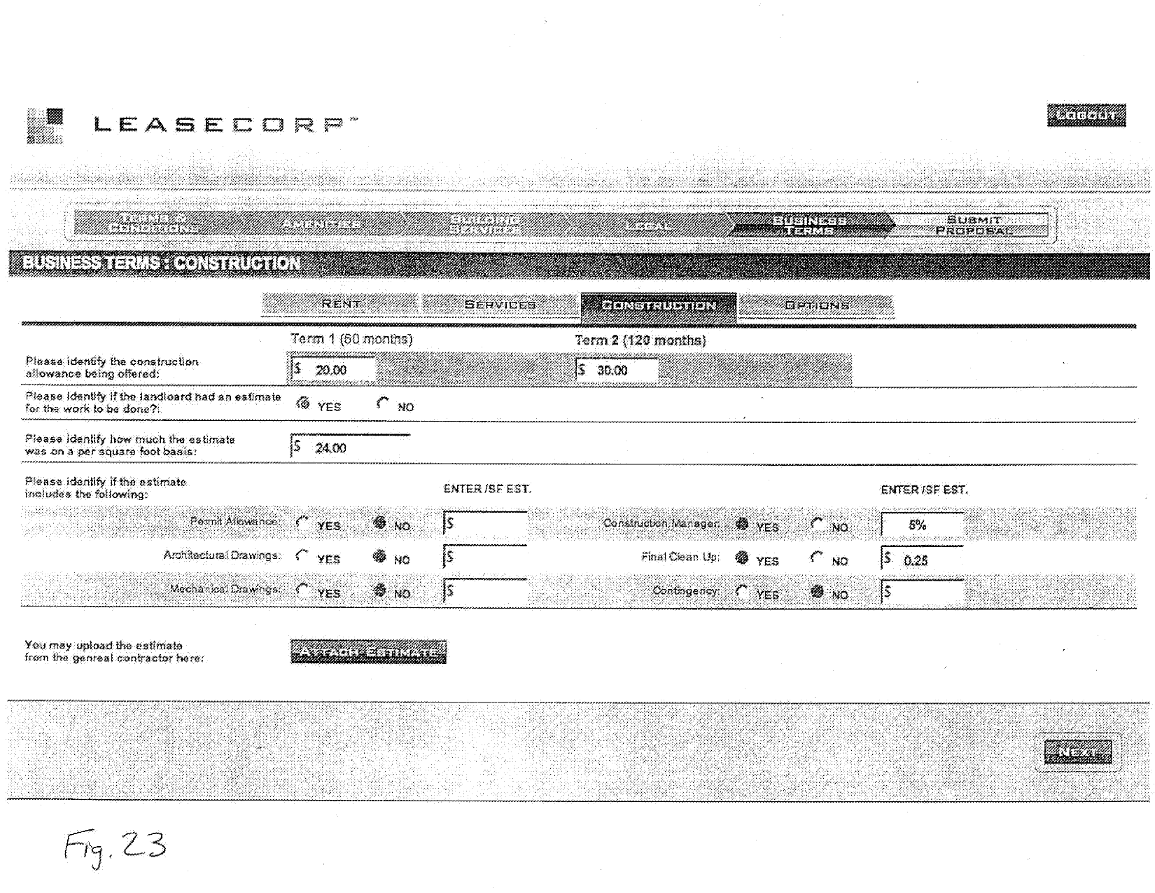

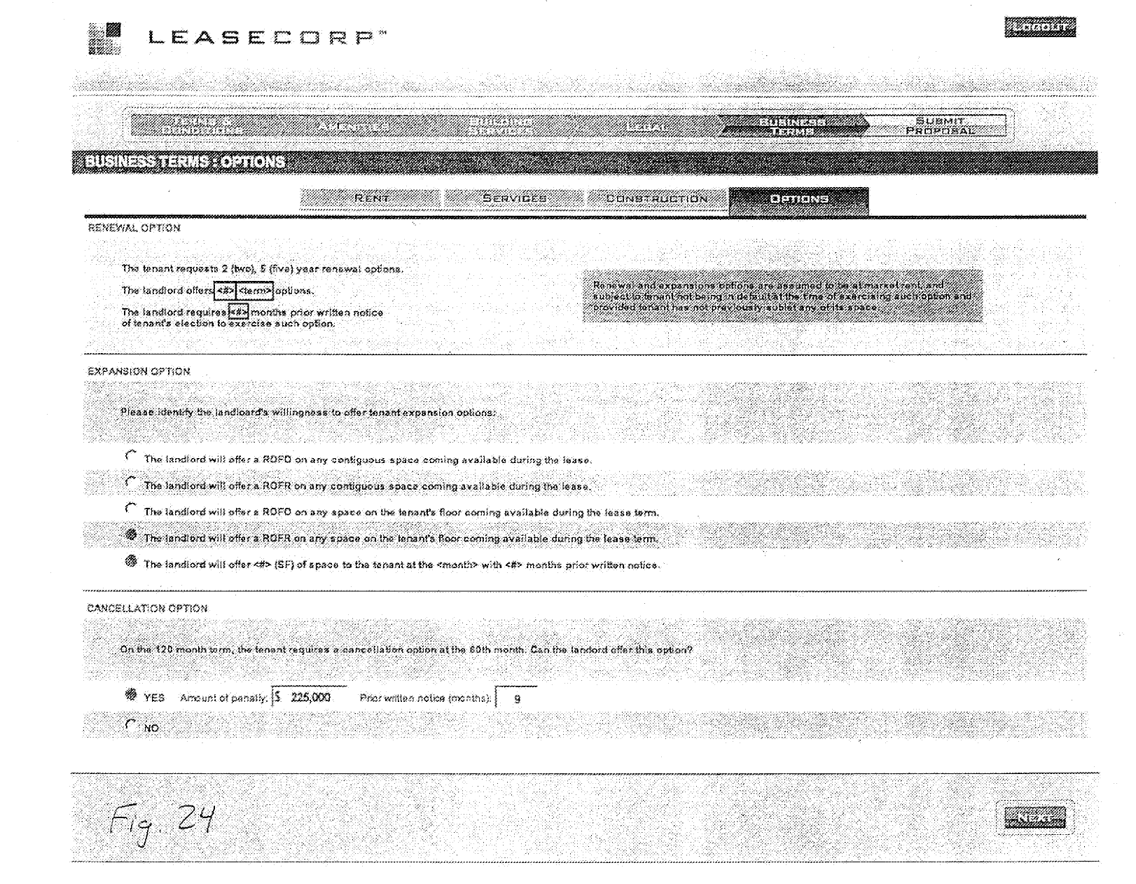

In this step, the landlord is asked to identify all of the economic terms of the various lease terms requested by the tenant in Phase 2, Step 3. These questions may be divided into four categories: Rent, with a corresponding screen illustrated in FIG. 21, Services, with a corresponding screen illustrated in FIG. 22, Construction, with a corresponding screen illustrated in FIG. 23, and Options, with a corresponding screen illustrated in FIG. 24. Examples of questions that the landlord will be required to answer via these screens include, but are not limited to: the rental rate for each term requested, whether taxes are included in the rental rate, whether operating expenses are included in the rental rate, a three year history of taxes and operating expenses, the year the building was built, the construction allowance the landlord is willing to offer, rent abatement the landlord is willing to offer, how charges for utilities will be handled, any parking fees that may be assessed to the tenant, the hours of operation of the building, the recognized vacation days for the building, the cost for after hours HVAC, the services that are included to tenant at no additional cost (i.e., janitorial and normal HVAC), and the like.

As with many previous steps, and as illustrated at 166 in FIG. 2, the system does not allow the landlord to submit the proposal unless every question of this step has been addressed. The landlord then has the opportunity, as illustrated by blocks 168, 170 and 172, to review their responses and modify them if necessary.

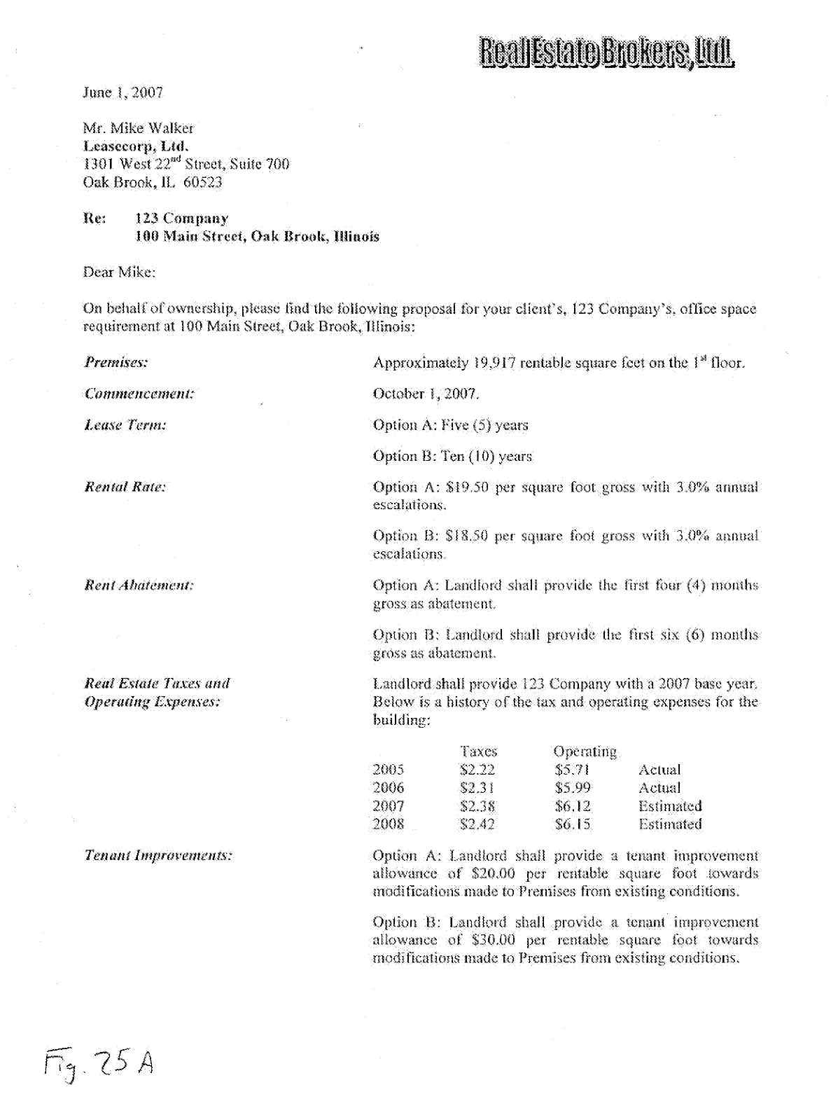

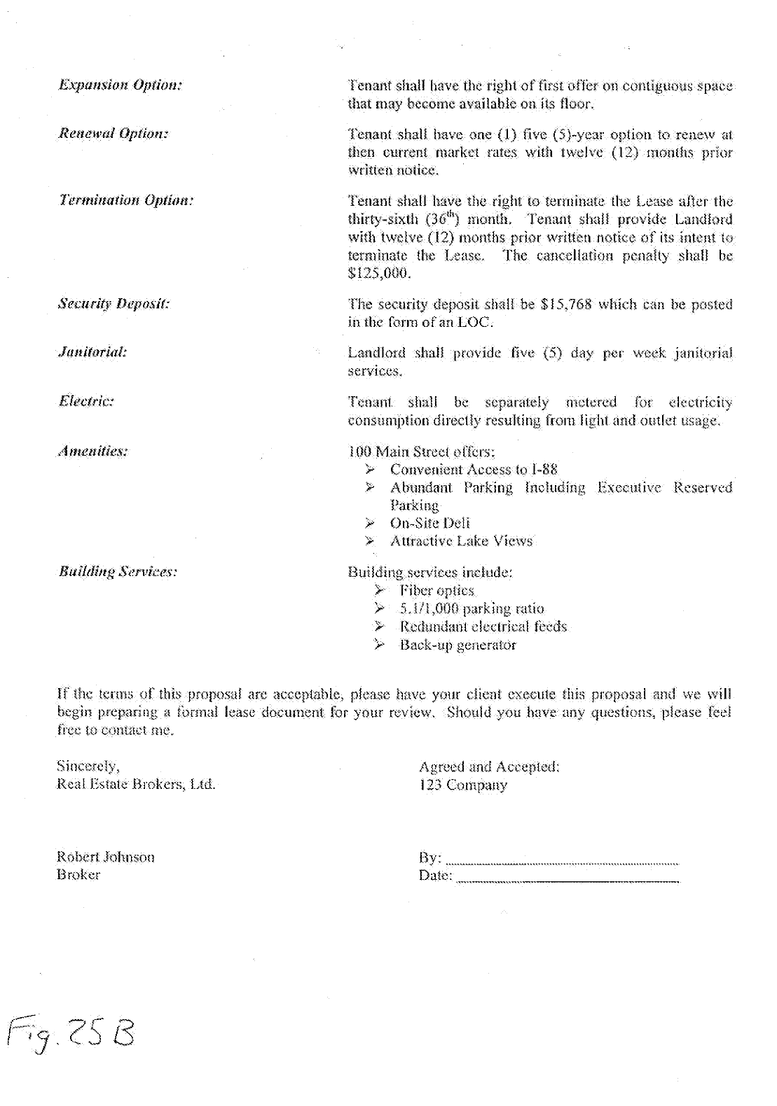

Once this is completed, as indicated at blocks 174, 176 and 178, the system allows the landlord to view their proposal before submitting to the tenant it for consideration and make any necessary changes. This ensures that the landlord does not submit incorrect information. Another feature allows the landlord the option to upload their company logo so that their proposal will appear to be generated by their company. As indicated by block 180, the landlord may then save or print the proposal. An example of a proposal is provided in FIGS. 25A and 25B.

The proposal from the landlord identifies every term and/or offering that the landlord has agreed to during the proposal process. This report can be viewed by the tenant or the landlord. The server 40 of FIG. 1 preferably includes a proposal archive database that allows the parties to view past proposals. As a result, a landlord may review past proposals when considering a lease with another tenant.

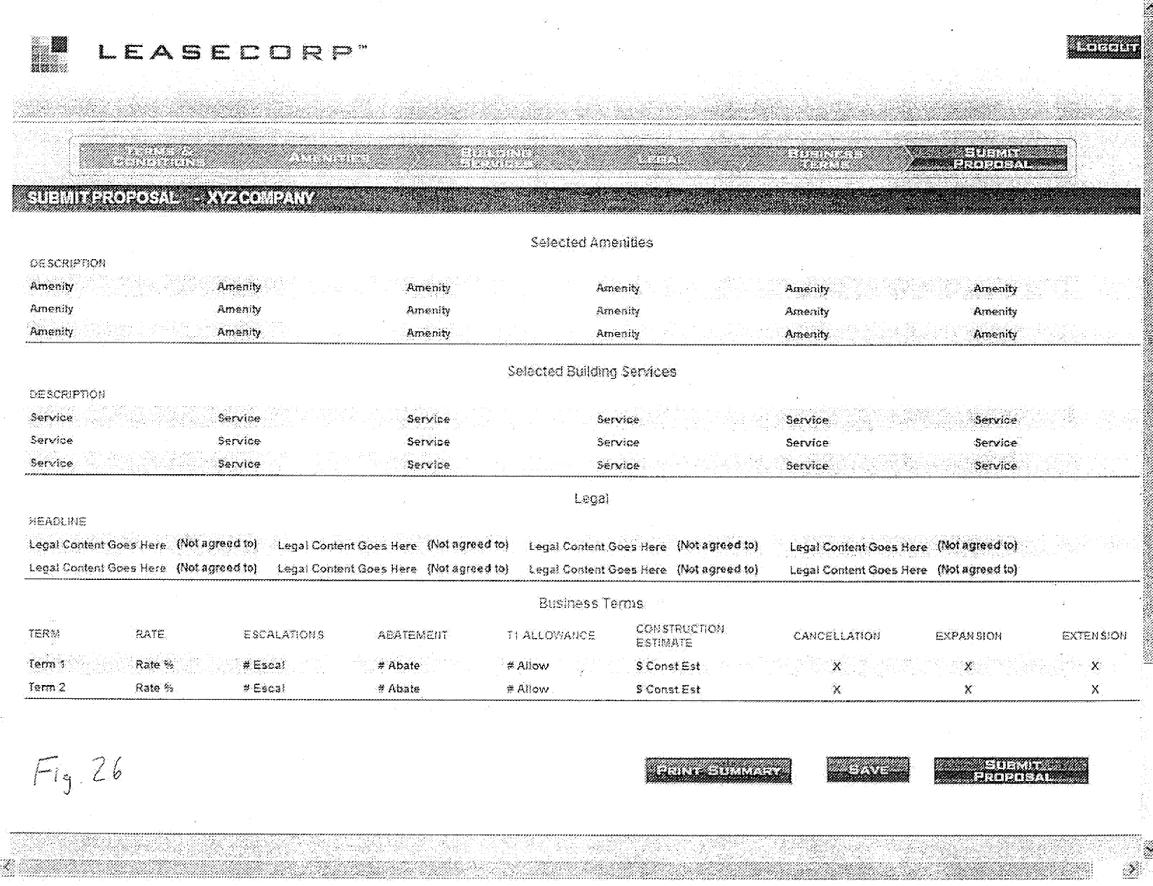

Once the landlord is satisfied with all of the terms identified in their proposal, they can simply hit the “Submit Proposal” button, as indicated by block 182 in FIGS. 2, which appears on the summary screen of FIG. 26, and the proposal is delivered to the tenant as indicated by block 184 of FIG. 2.

As indicated by block 186 in FIG. 2, the tenant receives (on workstation 44 of FIG. 1) notification of the landlord's submitted proposal via e-mail and accesses and logs onto the site on server 40 of FIG. 1. As indicated by block 188 of FIG. 2, the tenant may then review the landlords submitted proposal.

Once the proposal is delivered to the tenant, the system also includes several reporting features available to both tenant and landlord. As illustrated at blocks 202 and 204 in FIG. 2, the tenant can access, select and print these reports. The system permits the landlord to do the same. The various reports may be printed out by the tenant using printer 192 in FIG. 1 or by landlords using printers 194 through 196 of FIG. 1.

Reports available to the tenant include but are not limited to:

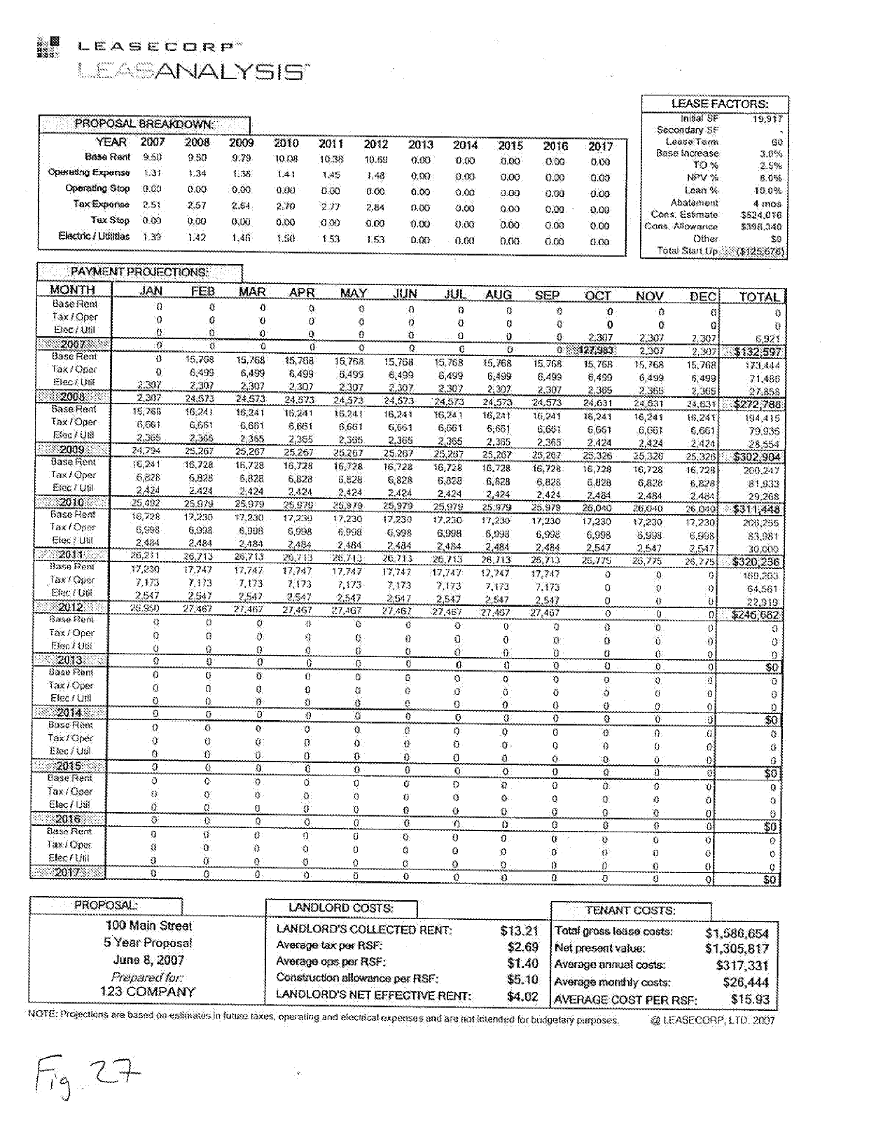

1. A Financial Summary report for each landlord proposal, an example of which is presented in FIG. 27. The page may provide itemized financial projections, broken down by monthly, yearly and total lease costs as well as net present values.

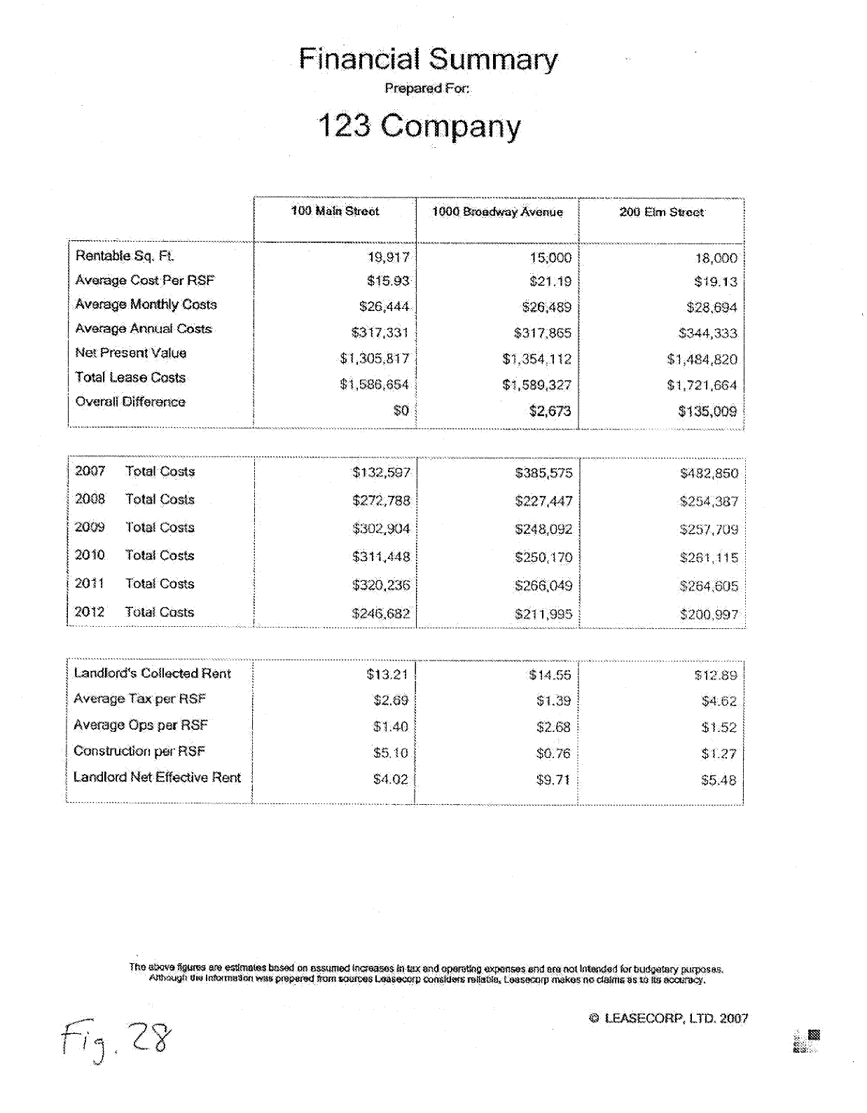

2. A Financial Summary Comparison report, an example of which is presented in FIG. 28, comparing all landlord's lease costs side by side.

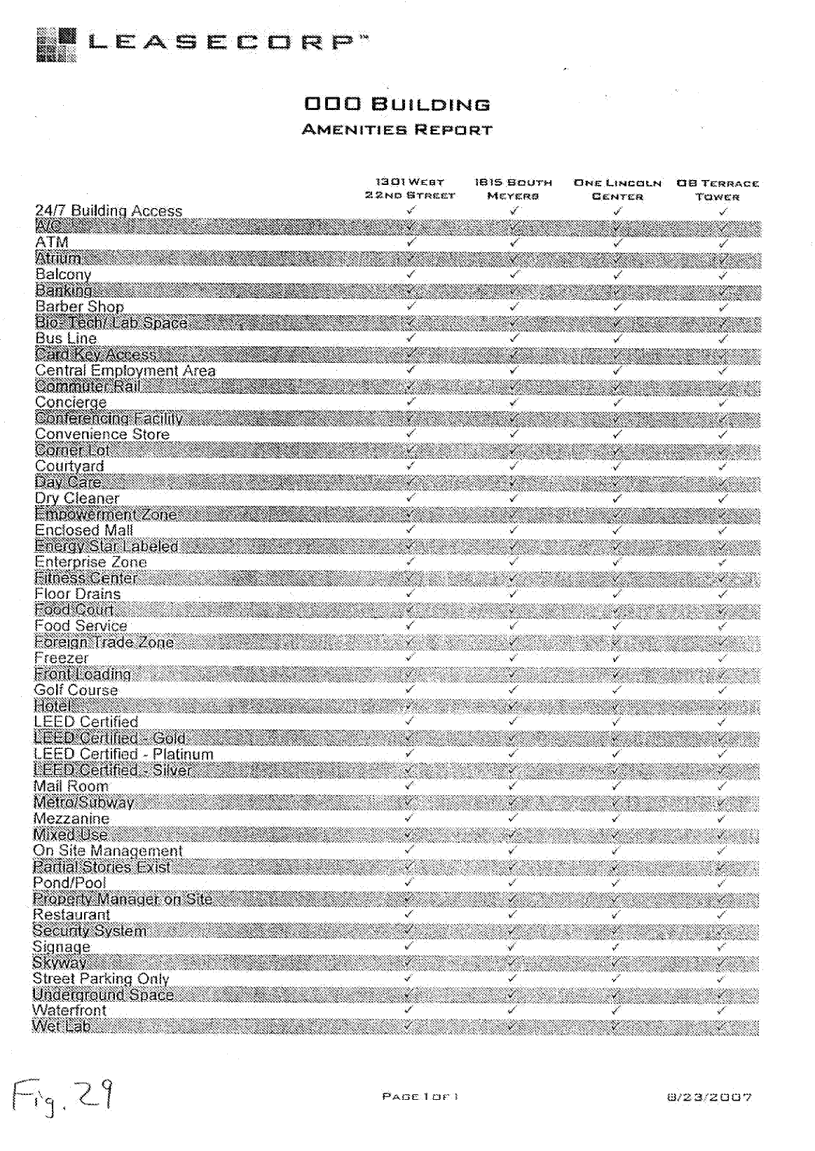

3. An Amenities Comparison report, an example of which is presented in FIG. 29, which provides a side by side summary of amenities that all of the buildings have or don't have, allowing the tenant to easily view which building under consideration has the amenities most desired by the tenant.

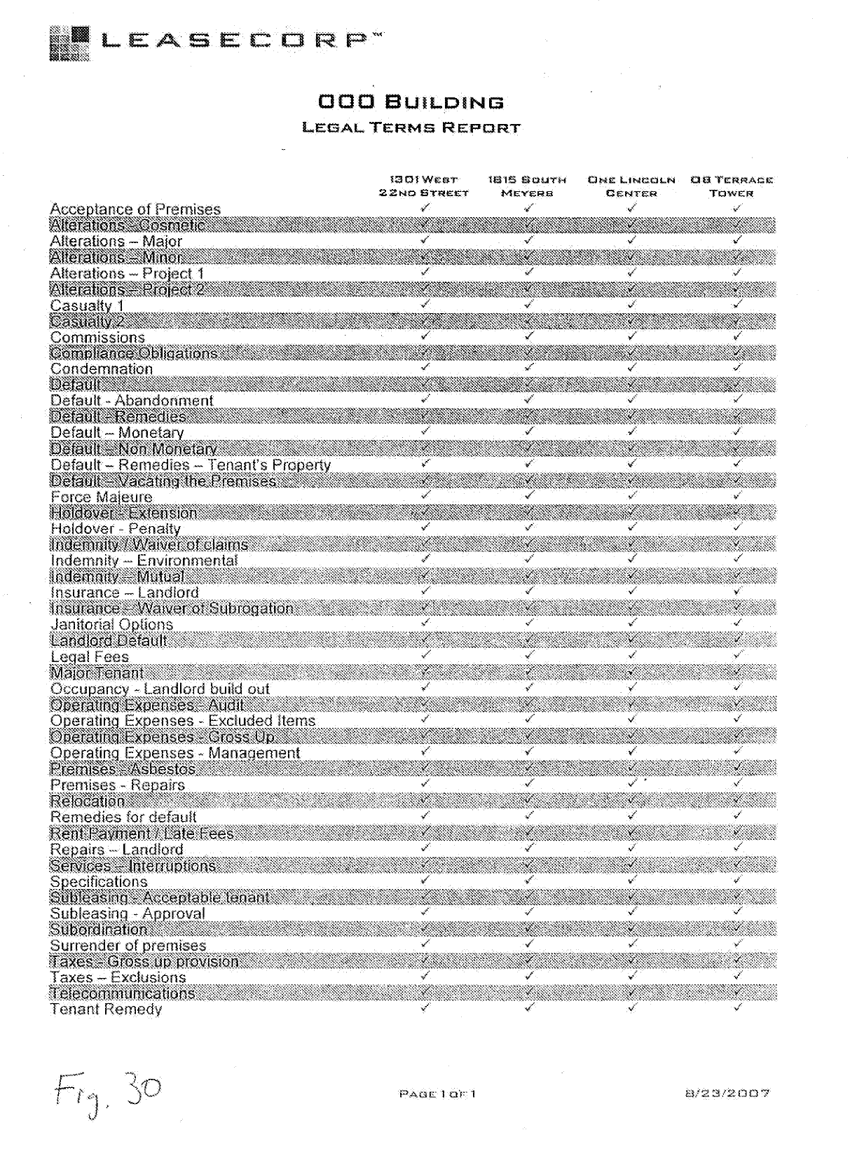

4. A Legal Terms Comparison report, an example of which is presented in FIG. 30, which provides a side by side summary of legal position that all of the buildings are taking relative to language in the lease, allowing the tenant to easily view which building under consideration is offering the most reasonable lease terms.

5. A side by side summary of building services that all of the buildings have or don't have, allowing the tenant to easily view which building under consideration has the building services most desired by the tenant

6. A side by side summary of the financial rental impact all of the buildings under consideration, allowing the tenant to easily view which building will be more or less expensive under a number of categories, including, but not limited to: average monthly rent over the lease term, average annual rent over the lease term, gross rental rate per square foot over the lease term, net present value, average estimated taxes for the building over the lease term, average estimated operating expenses for the building over the lease term, average construction allowance per square foot per year (including cost of money), average estimated electrical expenses over the lease term and landlords net lease rate per square foot over the lease term (gross lease costs minus construction costs, minus estimated electrical expenses, minus estimated operating expenses, minus estimated taxes).

An additional feature of the system allows a user to eventually (after enough transactions have been run through the system) run reports that identify trends in the market place. Some of the market trend information that the user is able to identify in a corresponding market trend report includes, but is not limited to: quoted rental rates for all buildings in a market, quoted rental rates for specific class buildings, amount of tenant construction allowance that various landlords are willing to offer, amount of rent abatement that landlords are willing to offer, legal modifications to standard lease documents that typically get accepted or not accepted, options that landlords are willing to offer (or not offer), and the like. Virtually, any information that is collected through the system and method of the invention is stored on a database of the system memory storage as market trend information and may be used to generate accompanying market trend reports.

The embodiment of the invention described above therefore provides a web based software application that facilitates the request and subsequent submittal of information a tenant (or tenant's representative) and a landlord (or landlord's representative) regarding the terms under which the parties would be willing to enter into a lease for commercial real estate. The system has three main functions: first, it allows the tenant (or tenant's rep) to generate a commission agreement, space plan authorization and request for proposal more quickly and efficiently than the current process used in the real estate industry; second, by use of mandatory field entries, it forces the landlord (or landlord's rep) to submit information in a specific order and format such that detailed reports and building comparisons can be generated and the tenant's representative is guaranteed that proposals cannot be submitted until other key steps in the process are completed; and third, allows tenants instant access to transaction progress, comparison reports, and comprehensive transaction information. The result is a much more efficient process of soliciting the terms of various potential real estate sites (and the cost implication associated with each) and a system that ensures that landlords proposals are complete and that tenant's commission agreements are always in place.

While the preferred embodiments of the invention have been shown and described, it will be apparent to those skilled in the art that changes and modifications may be made therein without departing from the spirit of the invention, the scope of which is defined by the appended claims.

What is claimed is:

1. A system for obtaining a lease proposal for a tenant from a landlord comprising:
a. a tenant workstation;
b. a landlord workstation;
c. a server in communication with the tenant and landlord workstations, said server having software and memory storage which permits a tenant to input tenant information using the tenant workstation and a landlord to input landlord information using the landlord workstation;
d. said software also permitting:
i) the tenant to generate a request for proposal having terms using the tenant information, transmit the request for proposal to the landlord workstation and review the landlord information; and
ii) the landlord to review the request for proposal, accept the terms of the request for proposal, generate a lease proposal using the tenant and landlord information and transmit the lease proposal to the tenant workstation.

2. The system of claim 1 further comprising additional landlord workstations and wherein the software permits the tenant to generate multiple requests for proposal and transmit them to multiple landlord workstations.

3. The system of claim 1 wherein the tenant information includes a list of buildings that it would like to receive proposals from.

4. The system of claim 1 wherein the tenant information includes a commission structure for a building.

5. The system of claim 1 wherein the tenant information includes a fee structure for space planning.

6. The system of claim 1 wherein the tenant information includes financial information for the tenant.

7. The system of claim 6 wherein the financial information includes the credit worthiness of the tenant.

8. The system of claim 1 wherein the landlord information includes drawings of a space in the landlord's building.

9. The system of claim 1 wherein the landlord information includes a list of amenities and services of the landlord's building.

10. The system of claim 1 wherein the landlord information includes lease terms.

11. The system of claim 1 wherein the memory storage stores tenant and landlord information used to generate past request for proposals and proposals as market trend information and said software uses the stored market trend information to generate market trend reports.

12. A method for obtaining a lease proposal for a tenant from a landlord comprising the steps of:
a. providing a computer system including a server, a tenant workstation and a landlord workstation where the tenant and landlord workstations communicate with the server over a network;
b. entering tenant information onto the server via the tenant workstation;
c. generating a request for proposal having terms on the server using the tenant information and the tenant workstation;
d. transmitting the request for proposal to the landlord workstation;
e. accepting the terms of the request for proposal using the landlord workstation;
f. generating a lease proposal on the server using the tenant information and the landlord workstation; and
g. transmitting the lease proposal to the tenant workstation.

13. The method of claim 12 further comprising additional landlord workstations and wherein multiple requests for proposal are generated and transmitted to multiple landlord workstations.

14. The method of claim 12 wherein the tenant information includes a list of buildings that it would like to receive proposals from.

15. The method of claim 12 wherein the tenant information includes a commission structure for a building.

16. The method of claim 12 wherein the tenant information includes a fee structure for space planning.

17. The method of claim 12 wherein the tenant information includes financial information for the tenant.

18. The method of claim 17 wherein the financial information includes the credit worthiness of the tenant.

19. The method of claim 12 further comprising the steps of the entering landlord information onto the server, said landlord information used to generate the lease proposal.

20. The method of claim 19 wherein the landlord information includes drawings of a space in the landlord's building.

21. The method of claim 19 wherein the landlord information includes a list of amenities and services of the landlord's building.

22. The method of claim 19 wherein the landlord information includes lease terms.

23. The method of claim 19 further comprising the steps of generating reports using the tenant and landlord information.

24. The method of claim 23 wherein the reports include a financial summary report for the lease proposal.

25. The method of claim 23 wherein the reports include a financial summary comparison report for multiple lease proposals.

26. The method of claim 23 wherein the reports include an amenities comparison report for multiple lease proposals.

27. The method of claim 23 wherein the reports include a legal terms comparison report for multiple lease proposals.

28. The method of claim 19 further comprising the steps of storing the tenant and landlord information used to generate past request for proposals and proposals as market trend information and generating market trend reports using the stored market trend information.

29. A method for obtaining a lease proposal for a tenant from a landlord comprising the steps of:
a. providing a computer system including a server, a tenant workstation and a landlord workstation where the tenant and landlord workstations communicate with the server over a network;
b. receiving tenant information on the server from the tenant workstation;
c. generating a request for proposal for the landlord having terms using the tenant information and the server;
d. transmitting the request for proposal from the server to the landlord workstation;
e. receiving on the server a request to accept the terms of the request for proposal from the landlord workstation;
f generating a proposal using the tenant information and the server; and
g. transmitting the proposal from the server to the tenant workstation.

30. The method of claim 29 further comprising additional landlord workstations and wherein multiple requests for proposals are generated and transmitted to multiple landlord workstations.

31. The method of claim 29 further comprising the steps of the receiving landlord information onto the server, said landlord information used to generate the lease proposal.

32. A machine-readable medium upon which has been prerecorded a computer program which, when executed by a computer, performs the following steps:
a. receives tenant information from a tenant workstation;
b. generates a request for proposal for a landlord having terms using the tenant information;
c. transmits the request for proposal to a landlord workstation;
d. receives a request to accept the terms of the request for proposal and landlord information from the landlord workstation;
e. generates a proposal using the tenant and landlord information; and
f. transmits the proposal to the tenant workstation.
